(19) United States
(12) Patent Application Publication
(10) Pub. No.: US 2021/0326897 A1
(43) Pub. Date: Oct. 21, 2021

(54) WORK PLAN DEVISING APPARATUS AND METHOD

(71) Applicant: Hitachi, Ltd., Tokyo (JP)

(72) Inventors: Naomi INOUE, Tokyo (JP); Satoshi FUKUDA, Tokyo (JP)

(21) Appl. No.: 17/123,425

(22) Filed: Dec. 16, 2020

(30) Foreign Application Priority Data
Apr. 21, 2020 (JP) 2020-075614

(51) Int. Cl. G06Q 30/00; G06Q 10/10; G06Q 10/06; G06F 16/23; G06N 20/00

(52) U.S. Cl. CPC G06Q 30/016; G06Q 10/10; G06Q 50/04; G06F 16/2379; G06N 20/00; G06Q 10/06316

(57) ABSTRACT

A work plan devising apparatus and method capable of devising an optimum work plan without manual intervention is proposed. A work plan devising apparatus for devising a work plan for work for orders from customers and a work plan devising method executed by the work plan devising apparatus are designed to expand rules, which are set in advance in association with the work, as necessary according to an evaluation result of each of one or more evaluation items regarding each customer on the basis of the above-mentioned preset rules and the evaluation result of each of the evaluation items regarding each customer and devise the work plan according to the expanded rules.

### CROSS-REFERENCE TO RELATED APPLICATION

The present application claims priority from Japanese application JP2020-075614, filed on Apr. 21, 2020, the contents of which is hereby incorporated by reference into this application.

### TECHNICAL FIELD

The present invention relates to a work plan devising apparatus and method and is suited for use in, for example, a work plan devising apparatus for devising a work plan for printing work at a printing factory.

### BACKGROUND ART

Conventionally, printing factories have been devising work plans every day according to orders from customers and conducting printing work in accordance with the devised work plans. In this case, such a work plan is devised by an expert in consideration of functions of equipment such as the maximum number of print colors which can be dealt with by each printing apparatus, performance of the equipment such as quality, and delivery dates.

Incidentally, PTL 1 discloses a work plan devising system which devises a work plan by assigning a work schedule for manufacturing, for example, components to the equipment and is designed so that the system can easily compare evaluation values of a plurality of proposed plans to each other and verify them and easily modify the proposed plans.

### CITATION LIST

### PATENT LITERATURE

PTL 1: Japanese Patent Application Laid-Open (Kokai) Publication No. 2007-133888

### SUMMARY OF THE INVENTION

### PROBLEMS TO BE SOLVED BY THE INVENTION

Meanwhile, in some cases, it may be impossible to devise a work plan according to which delivery dates of all orders can be met, depending on the number of orders or the content of the orders. In such a case, conventionally, a work plan is devised on the premise that the delivery dates of some orders will be delayed; and negotiations are conducted with a customer(s), whose delivery dates will be delayed, via a salesperson, in order to delay the delivery dates; and if their consent fails to be obtained, manual adjustments of the work plan are made by delaying delivery dates of orders of other customers who are generous regarding the delivery dates.

However, this is the circumstance where all the content of the negotiations with the customers at that time and the management of the customers who are generous regarding the delivery dates are accumulated only as knowhow of another system or expert; and there has been such a problem that it is difficult even for the work plan devising system disclosed in PTL 1 to devise an optimum work plan systematically.

The present invention was devised in consideration of the above-described circumstances and aims at proposing a work plan devising apparatus and method capable of devising an optimum work plan without manual intervention.

### MEANS TO SOLVE THE PROBLEMS

In order to solve the above-described problem, provided according to an aspect of the present invention is a work plan devising apparatus for devising a work plan for work for orders from customers, wherein the plan devising apparatus includes: a first storage apparatus that stores rules which are set in advance in association with the work; a second storage apparatus that stores an evaluation result of each of one or more evaluation items regarding each of the customers; and a plan devising processing unit that devises the work plan on the basis of the rules by using the evaluation result of each evaluation item regarding the customers; and wherein the plan devising processing unit expands the rules as necessary according to the evaluation result of each evaluation item regarding each customer and devises the work plan according to the expanded rules.

Furthermore, provided according to another aspect of the present invention is a work plan devising method executed by a work plan devising apparatus for devising a work plan for work for orders from customers, wherein the work plan devising method includes: a first step of storing rules which are set in advance in association with the work and storing an evaluation result of each of one or more evaluation items regarding each of the customers; and a second step of devising the work plan on the basis of the rules by using the evaluation result of each evaluation item regarding the customers; and wherein in the second step, the rules are expanded as necessary according to the evaluation result of each evaluation item regarding each customer and the work plan is devised according to the expanded rules.

The work plan devising apparatus and method according to the present invention can devise a work plan in which the evaluation of each evaluation item regarding the customers is reflected.

### ADVANTAGEOUS EFFECTS OF THE INVENTION

The work plan devising apparatus and method capable of devising an optimum work plan without manual intervention can be implemented according to the present invention.

### BRIEF DESCRIPTION OF DRAWINGS

FIG. 1 is a block diagram illustrating an overall configuration of a work plan devising system according to this embodiment;

FIG. 2 is a chart illustrating a configuration example of an order management table;

FIG. 3 is a chart illustrating a configuration example of a claim information management table;

FIG. 4 is a chart illustrating a configuration example of a customer evaluation management table;

FIG. 5 is a chart illustrating a configuration example of a machine management table;

FIG. 6 is a chart illustrating a configuration example of an evaluation item management table;

FIG. 7 is a chart illustrating a configuration example of an equipment rule management table;

FIG. 8 is a chart illustrating a configuration example of a customer rule management table;

FIG. 9 is a chart illustrating a configuration example of a rule applicability management table;

FIG. 10 is a chart illustrating a configuration example of a setting condition management table;

FIG. 11 is a diagram illustrating a screen configuration example of an administrator menu screen;

FIG. 12 is a diagram illustrating a screen configuration example of an evaluation item setting screen;

FIG. 13 is a diagram illustrating a screen configuration example of an equipment rule setting screen;

FIG. 14 is a diagram illustrating a screen configuration example of a customer rule setting screen;

FIG. 15 is a diagram illustrating a screen configuration example of a plan devising menu screen;

FIG. 16 is a diagram illustrating a screen configuration example of a plan devising screen;

FIG. 17 is a diagram illustrating a screen configuration example of a devised plan result display screen;

FIG. 18 is a diagram illustrating a screen configuration example of the devised plan result display screen;

FIG. 19 is a diagram illustrating a screen configuration example of a customer evaluation screen;

FIG. 20 is a flowchart illustrating a processing sequence for rule setting processing;

FIG. 21 is a flowchart illustrating a processing sequence for work plan devising processing;

FIG. 22 is a flowchart illustrating a processing sequence for plan optimization processing;

FIG. 23 is a flowchart illustrating a processing sequence for plan devising processing;

FIG. 24 is a flowchart illustrating a processing sequence for first evaluation learning processing; and

FIG. 25 is a flowchart illustrating a processing sequence for second evaluation learning processing.

### DESCRIPTION OF EMBODIMENTS

An embodiment of the present invention will be explained in detail with reference to the drawings.

### (1) Configuration of Work Plan Devising System According to This Embodiment

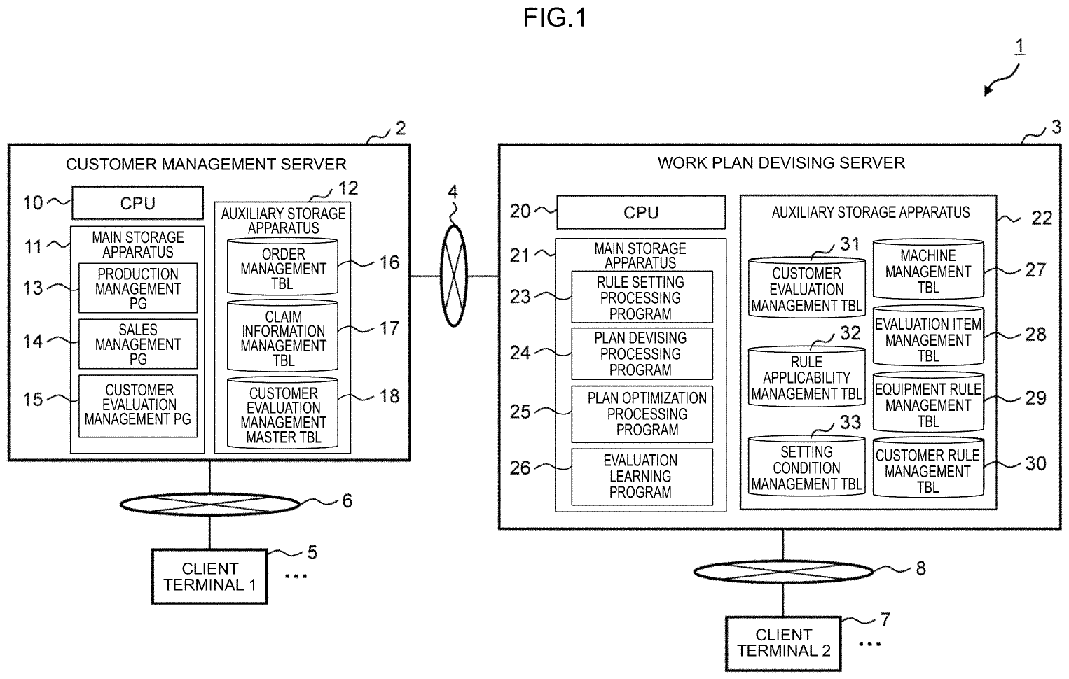

Referring to FIG. 1, the reference numeral 1 represents a work plan devising system according to this embodiment as a whole. This work plan devising system 1 is configured by including a customer management server 2 and a work plan devising server 3 which are connected via a first network 4. Furthermore, a first client terminal 5 which is used by a salesperson in charge is connected to the customer management server 2 via a second network 6; and a second client terminal 7 which is used by a work plan devising person in charge who devises a work plan for printing work is connected to the work plan devising server 3 via a third network 8.

The customer management server 2 is a server apparatus for storing and managing, for example, information about each received order registered by the salesperson in charge via the first client terminal 5 (hereinafter referred to as the “order information”), information about each claim made by a customer(s) (hereinafter referred to as the “claim information”), and evaluation information from the salesperson in charge regarding each customer (hereinafter referred to as the “customer evaluation information”).

This customer management server 2 is composed of a general-purpose server apparatus equipped with information processing resources such as a CPU (Central Processing Unit) 10, a main storage apparatus 11, and an auxiliary storage apparatus 12. The CPU 10 is a processor which controls the operations of the entire customer management server 2. Furthermore, the main storage apparatus 11 is composed of, for example, a nonvolatile semiconductor memory and is used as a work memory for the CPU 10. A production management program 13, a sales management program 14, and a customer evaluation management program 15 which will be described later are read from the auxiliary storage apparatus 12 when activating the customer management server 2 or whenever necessary and are stored and retained in this main storage apparatus 11.

The auxiliary storage apparatus 12 is composed of, for example, a large-capacity, nonvolatile storage apparatus such as a hard disk drive or an SSD (Solid State Drive) and is used to save programs and necessary information for a long period of time. An order management table 16, a claim information management table 17, and a customer evaluation management master table 18 which will be described later are also stored and retained in this auxiliary storage apparatus.

The work plan devising server 3, like the customer management server 2, is composed of a general-purpose server apparatus which is equipped with a CPU 20, a main storage apparatus 21, and an auxiliary storage apparatus 22. Functions and configurations of the CPU 20, the main storage apparatus 21, and the auxiliary storage apparatus 22 are similar to those of the CPU 10, the main storage apparatus 11, and the auxiliary storage apparatus 12 for the customer management server 2, so that any explanation about them is omitted here.

A rule setting processing program 23, a plan devising processing program 24, a plan optimization processing program 25, and an evaluation learning program 26 which will be described later and which are read from the auxiliary storage apparatus 22 when activating the work plan devising server 3 or whenever necessary are stored in the main storage apparatus 21 for the work plan devising server 3. Furthermore, a machine management table 27, an evaluation item management table 28, an equipment rule management table 29, a customer rule management table 30, a customer evaluation management table 31, a rule applicability management table 32, and a setting condition management table 33 which will be described later are stored in the auxiliary storage apparatus 22 for the work plan devising server 3.

The first and second client terminals 5, 7 are composed of, for example, personal computer devices. As the first client terminal 5 communicates with the customer management server 2 via the second network 6 and the second client terminal 7 communicates with the work plan devising server 3 via the third network 8, necessary data are exchanged between the customer management server 2 and the work plan devising server 3. Incidentally, the second and third networks 6, 8 may be the same network and, furthermore, the first to third networks 4, 6, 8 may be the same network.

### (2) Work Plan Devising Function According to This Embodiment

Next, a work plan devising function with which the work plan devising server 3 according to this embodiment is equipped will be explained. This work plan devising function is a function that devises a work plan for printing work during a designated period on the basis of each of the order information, the claim information, and the customer evaluation information which are registered in the customer management server 2, and various kinds of rules which are set by the work plan devising person in charge via the second client terminal 7. Furthermore, the work plan devising server 3 learns the customer evaluation on the basis of this work plan devising function, expands the various kinds of rules, which are set by the work plan devising person in charge, as necessary on the basis of the learned customer evaluation, and redevises the work plan according to the expanded rules.

As means for implementing the above-described work plan devising function according to this embodiment, the production management program 13, the sales management program 14, and the customer evaluation management program 15 are stored in the main storage apparatus 11 for the customer management server 2 and the order management table 16, the claim information management table 17, and the customer evaluation management master table 18 are stored in the auxiliary storage apparatus 12 for the customer management server 2 as illustrated in FIG. 1.

The production management program 13 is a program having a function that registers and manages each piece of the order information, which is registered by the salesperson in charge via the first client terminal 5, in the order management table 16. Furthermore, the sales management program 14 is a program having a function that registers and manages each piece of the claim information, which is registered by the salesperson in charge via the first client terminal 5, in the claim information management table 17.

Furthermore, the customer evaluation program 15 is a program having a function that registers and manages the evaluation information of the salesperson in charge regarding each customer (hereinafter referred to as the customer evaluation information), which is registered by the salesperson in charge via the first client terminal 5, in the customer evaluation management master table 18.

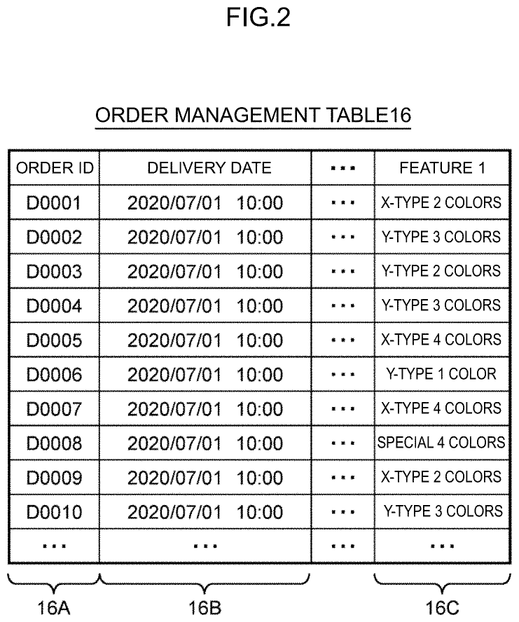

The order management table 16 is configured, as illustrated in FIG. 2, by including at least an order ID column 16A, a delivery date column 16B, and a feature column 16C. Regarding the order management table 16, one row corresponds to one order registered by the salesperson in charge.

Then, the order ID column 16A stores a unique identifier of the relevant order, which is assigned to that relevant order; and the delivery date column 16B stores a delivery date of that order. Furthermore, the feature column 16C stores a feature of the relevant order. Therefore, in the case of the example in FIG. 2, it is shown that the delivery date of the order to which the order ID “D0001” is assigned is “2020/07/01, 10:00” and the order is placed for a printed matter having the feature of “X-TYPE 2 COLORS.”

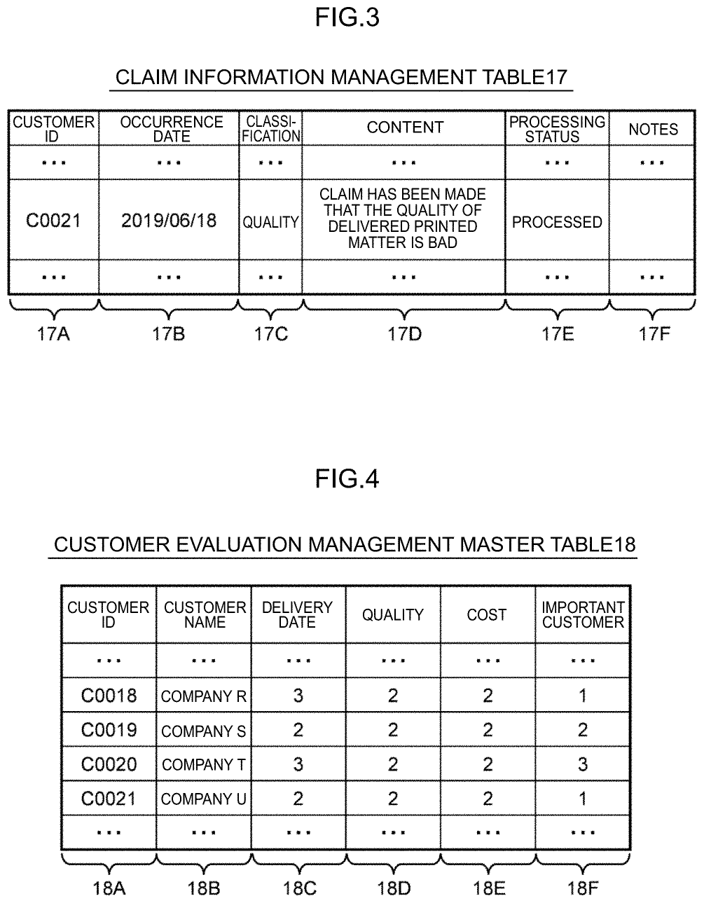

The claim information management table 17 is configured, as illustrated in FIG. 3, by including a customer ID column 17A, an occurrence date column 17B, a classification column 17C, a content column 17D, a processing status column 17E, and a notes column 17F. Regarding the claim information management table 17, one row corresponds to one claim (claim information) from a customer.

Then, the customer ID column 17A stores a unique identifier of the relevant customer (a customer ID), which is assigned to the customer who made the relevant claim; and the occurrence date column 17B stores the date when the relevant claim was accepted. Moreover, the classification column 17C stores the classification of the content of that claim (such as the quality, delivery date, or cost); and the content column 17D stores specific content of that claim. Furthermore, the processing status column 17E stores the processing status of the relevant claim (“PROCESSED” or “IN PROCESS”); and the notes column 17F stores remarks information registered by the salesperson in charge.

Therefore, in the case of the example in FIG. 3, it is shown that a “CLAIM HAS BEEN MADE THAT THE QUALITY OF DELIVERED PRINTED MATTER IS BAD” regarding the “QUALITY” from the customer with the customer ID “C0021” on “2019/06/18”; and this claim has already been “PROCESSED.”

The customer evaluation management master table 18 is configured, as illustrated in FIG. 4, by including a customer ID column 18A, a customer name column 18B, a delivery date column 18C, a quality column 18D, a cost column 18E, and an important customer column 18F. Regarding the customer evaluation management master table 18, one row corresponds to one customer evaluation (the customer evaluation information).

Then, the customer ID column 18A stores a customer ID of the relevant customer; and the customer name column 18B stores the name of that customer (customer name). Furthermore, the delivery date column 18C, the quality column 18D, and the cost column 18E store the customer's severity evaluated by the salesperson in charge with respect to the delivery date, the quality, and the cost, respectively. FIG. 4 shows an example of a case where such evaluation is conducted as three-level evaluation, so that “1” means the most generous, “2” means generous, and “3” means severe.

Furthermore, the important customer column 18F stores the importance of the relevant customer, which is set by the salesperson in charge in consideration of the prior sales, the number of orders placed, and the frequency of order placement. FIG. 4 shows an example of a case where the importance is evaluated as three-level evaluation, so that “3” represents the highest importance, “2” represents the second highest importance, and “1” represents the lowest importance. These levels of importance are updated by the salesperson in charge as appropriate on the basis of the sales to the relevant customer and the number of orders and the frequency of order placement from that customer.

Therefore, in the case of the example in FIG. 4, it is shown that the customer evaluation by the salesperson in charge of “COMPANY R” to which the customer ID “C0018” is assigned is “3” regarding the delivery date, “2” regarding the quality, and “2” regarding the cost. Furthermore, this drawing shows that the importance of that customer is set as “1.”

Meanwhile, as it is also apparent from FIG. 1, the rule setting processing program 23, the plan devising processing program 24, the plan optimization processing program 25, and the evaluation learning program 26 are stored in the main storage apparatus 21 for the work plan devising server 3 and the machine management table 27, the evaluation item management table 28, the equipment rule management table 29, the customer rule management table 30, the customer evaluation management table 31, the rule applicability management table 32, and the setting condition management table 33 are stored in the auxiliary storage apparatus 22 for the work plan devising server 3.

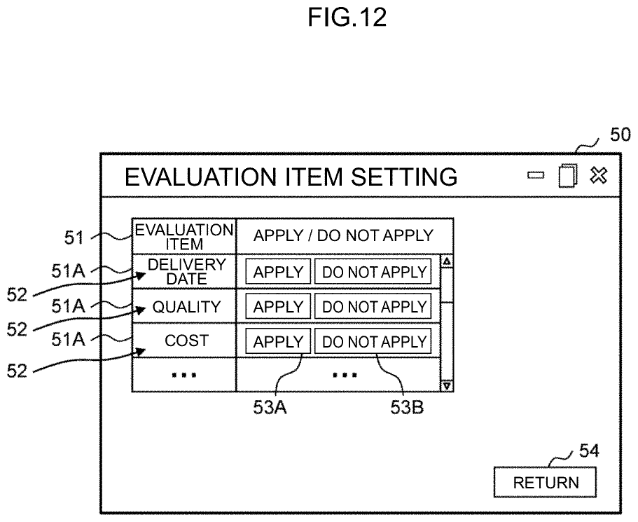

The rule setting processing program 23 is a program having a function that displays various kinds of screens, which will be described later with reference to FIG. 12 to FIG. 14 and are used by the work plan devising person in charge to set various kinds of rules in advance that should be applied when the work plan devising server 3 devises the work plan, on the second client terminal 7. The rule setting processing program 23 manages the various kinds of rules, which are set by the work plan devising person in charge by using such various kinds of screens, by registering them in the rule applicability management table 32 and the setting condition management table 33, which will be described later, and updating the equipment rule management table 29 and the customer rule management table 30 on the basis of these respective rules.

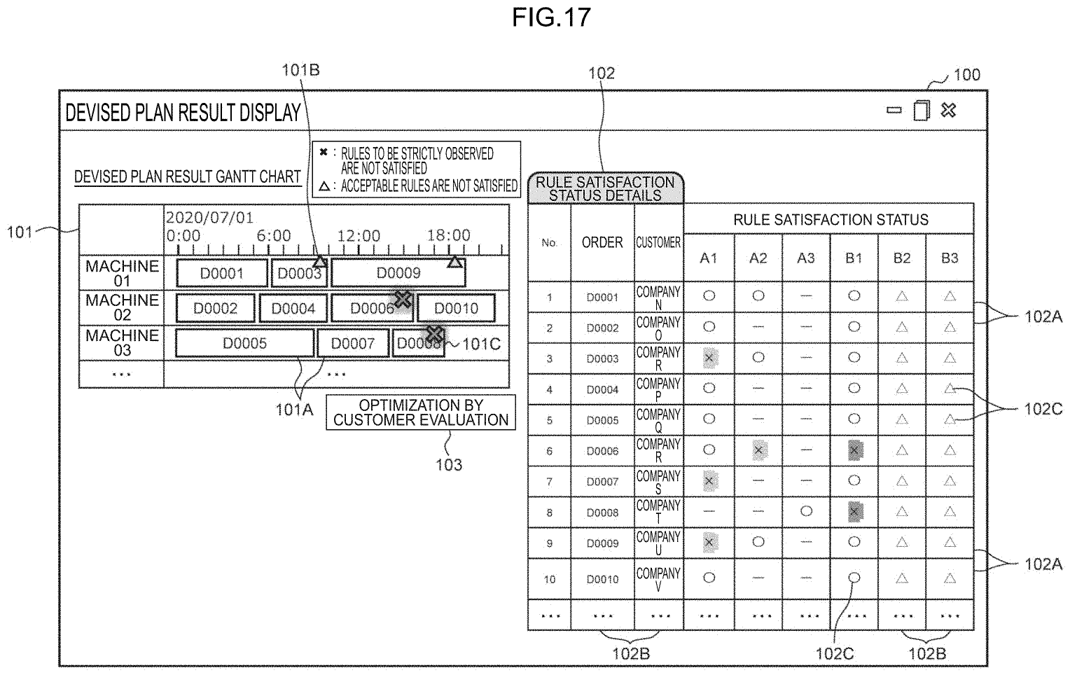

Moreover, the plan devising processing program 24 is a program having a function that devises a work plan for the printing work at a printing factory on the basis of each order information registered in the order management table 16 for the customer management server 2 and the aforementioned various kinds of rules which are set by the work plan devising person in charge. The plan devising processing program 24 generates a devised plan result display screen 100, which will be described later with reference to FIG. 17, on the basis of the devised work plan and displays the generated devised plan result display screen 100 on the second client terminal 7.

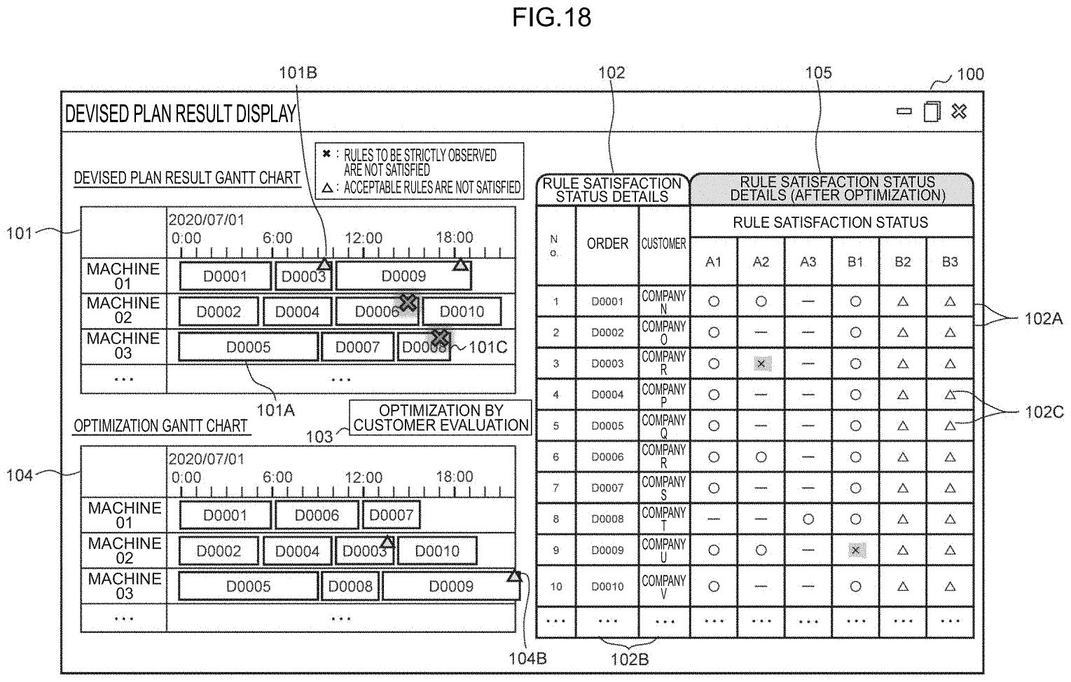

The plan optimization processing program 25 is a program having a function that optimizes the work plan devised by the plan devising processing program 24 on the basis of each customer evaluation information registered in the customer evaluation management table 31, which will be described later, and each claim information registered in the claim information management table 17 for the customer management server 2. The plan optimization processing program 25 generates an optimization Gantt chart 104, which will be described later with reference to FIG. 18, on the basis of the optimized work plan and displays the generated optimization Gantt chart 104 on the devised plan result display screen 100.

The evaluation learning program 26 is a program having a function that updates the customer evaluation management table 31 as appropriate on the basis of each customer evaluation information registered in the customer evaluation management master table 18 for the customer management server 2 and each claim information registered in the claim information management table 17 for the customer management server 2.

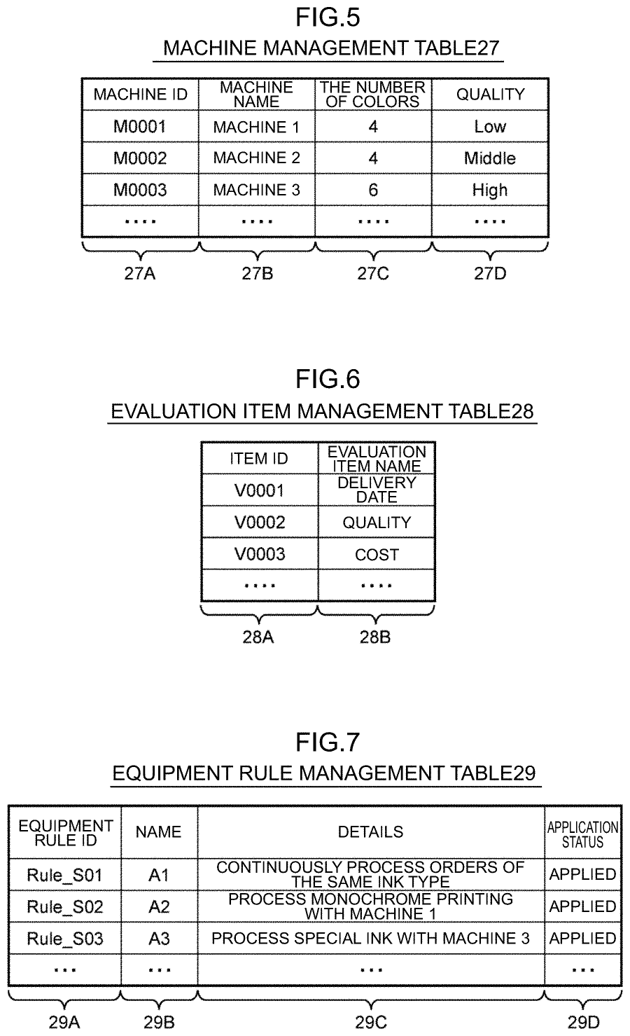

The machine management table 27 is a table used to manage each printing machine installed within the printing factory and is created in advance by the work plan devising person in charge. This machine management table 27 is configured, as illustrated in FIG. 5, by including a machine ID column 27A, a machine name column 27B, a number-of-colors column 27C, and a quality column 27D. Regarding the machine management table 27, one row corresponds to one printing machine installed within the printing factory.

Then, the machine ID column 27A stores a unique identification number of the relevant printing machine (machine ID), which is assigned to the relevant printing machine; and the machine name column 27B stores a unique name of that printing machine, which is given to the relevant printing machine. Furthermore, the number-of-colors column 27C stores the maximum number of print colors which are available with the relevant printing machine; and the quality column 27D stores the quality of a printed matter which is printed by the relevant printing machine.

Therefore, in the case of the example in FIG. 5, it is shown that a printing machine called “Machine 1” which is assigned the machine ID “M0001” can be used for four-color printing at maximum and the quality of a printed matter created by using this printing machine is “Low.”

Moreover, the evaluation item management table 28 is a table used to manage items, each of which should be evaluated by the salesperson in charge regarding each customer (hereinafter referred to as the “evaluation items”), and is created by the work plan devising person in charge in advance. This evaluation item management table 28 is configured, as illustrated in FIG. 6, by including an item ID column 28A and an evaluation item name column 28B. Regarding the evaluation item management table 28, one row corresponds to one evaluation item.

Then, the item ID column 28A stores a unique identifier of the relevant evaluation item (item ID), which is assigned to the relevant evaluation item; and the evaluation item name column 28B stores the name of the relevant evaluation item (evaluation item name).

Therefore, in the case of the example in FIG. 6, it is shown that at least the “delivery date,” “quality,” and “cost” are set as such evaluation items and the item ID's “V0001,” “V0002,” and “V0003” are assigned to these evaluation items, respectively.

The equipment rule management table 29 is a table used to manage rules regarding the equipment, which are set in advance by the work plan devising person in charge (hereinafter referred to as the “equipment rules”), among the rules to be observed when the work plan devising server 3 devises the work plan. This equipment rule management table 29 is configured, as illustrated in FIG. 7, by including an equipment rule ID column 29A, a name column 29B, a details column 29C, and an application status column 29D. Regarding the equipment rule management table 29, one row corresponds to one equipment rule that is set by the work plan devising person in charge.

Then, the equipment rule ID column 29A stores a unique identifier of the relevant equipment rule (equipment rule ID), which is assigned to the relevant equipment rule; and the name column 29B stores a unique name of the relevant equipment rule, which is assigned to that equipment rule. Furthermore, the details column 29C stores the details (specific content) of the relevant equipment rule. Furthermore, the application status column 29D stores information indicating whether or not the relevant equipment rule is applied now as a rule which should be observed when the work plan devising server 3 devises the work plan (“APPLIED” if it is applied; and “NOT APPLIED” if it is not applied).

Therefore, in the case of the example in FIG. 7, it is shown that, for example, the equipment rule with the name “A1” to which the equipment rule ID “Rule_S01” is assigned is a rule to “CONTINUOUSLY PROCESS ORDERS OF THE SAME INK TYPE (by using the same printing machine)”; and it is set that such equipment rule should be applied when the work plan devising server 3 devises the work plan.

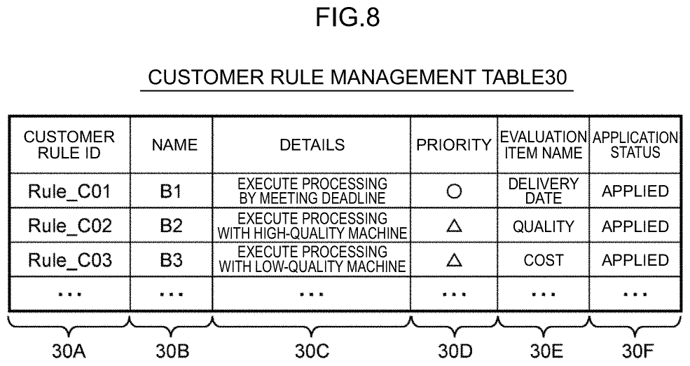

The customer rule management table 30 is a table used to manage rules about customers, which are set in advance by the work plan devising person in charge (hereinafter referred to as the “customer rules”), among the rules to be observed when the work plan devising server 3 devises the work plan. This customer rule management table 30 is configured, as illustrated in FIG. 8, by including a customer rule ID column 30A, a name column 30B, a details column 30C, a priority column 30D, an evaluation item name column 30E, and an application status column 30F. Regarding the customer rule management table, one row corresponds to one customer rule that is set by the work plan devising person in charge.

Then, the customer rule ID column 30A stores a unique identifier of the relevant customer rule (customer rule ID), which is assigned to that customer rule; and the name column 30B stores a unique name of the customer rule, which is given to that customer rule. Furthermore, the details column 30C stores the details (specific content) of the relevant customer rule.

The priority column 30D stores priority when applying the relevant customer rule. In the case of this embodiment, such priority is set in three levels, that is, “to be observed absolutely strictly,” “to be observed if possible,” and “to be considered to some degree.” Incidentally, in FIG. 8 and subsequent drawings, “to be observed absolutely strictly” is expressed as “∘,” “to be observed if possible” is expressed as “Δ,” and “to be considered to some degree” is expressed as “−.”

Moreover, the evaluation item name column 30E stores the name of an evaluation item to which the relevant customer rule is applied; and the application status column 30F stores information indicating whether or not the relevant customer rule is applied as a rule which should be observed when the work plan devising server 3 devises the work plan (“APPLIED” if it is applied; and “NOT APPLIED” if it is not applied).

Therefore, in the case of the example in FIG. 8, it is shown that the equipment rule with the name “B1” to which the customer rule ID “Rule_C01” is assigned is a rule to “EXECUTE PROCESSING BY MEETING DEADLINE” regarding the evaluation item of the “delivery date”; its priority is set as “∘ (to be observed absolutely strictly)”; and that equipment rule is applied now as the rule which should be observed when the work plan devising server 3 devises the work plan (“APPLIED” in the application status column).

The customer evaluation management table 31 is a table to retain the customer evaluation information, which is stored in the customer evaluation management master table 18 for the customer management server 2, on the work plan devising server 3 side and is updated as appropriate by learning as described later. This customer evaluation management table 31 has the configuration similar to that of the customer evaluation management master table 18 described earlier with reference to FIG. 4, so that any explanation about it is omitted here.

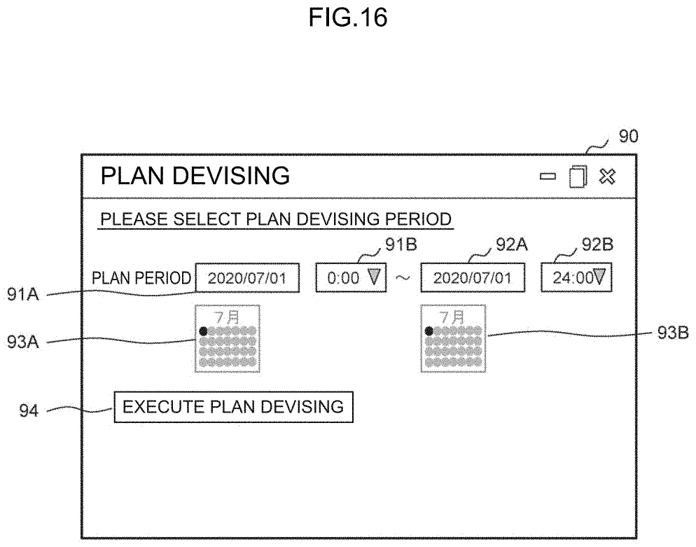

The rule applicability management table 32: is a table indicating which rules (the equipment rule(s) and the customer rule(s)) should be applied to each order which should be processed within the period of time designated by using a plan devising screen 90 described later with reference to FIG. 16 (hereinafter referred to as the “target order”; and is temporarily created by this work plan devising server 3 in the process of executing the work plan devising processing. Regarding the rule applicability management table 32, one row corresponds to one target order.

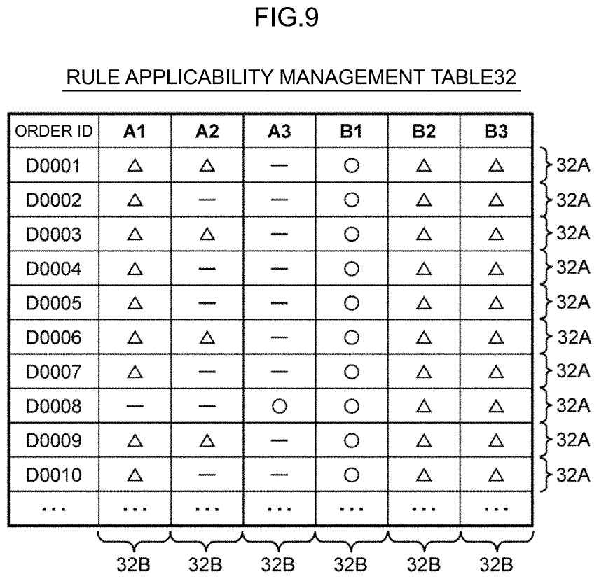

Then, regarding the rule applicability management table 32, each row 32A is divided into applicability columns 32B which correspond to the equipment rules and the customer rules, respectively, that are then set; and each of these applicability columns 32B stores information indicating whether or not the relevant equipment rule or customer rule should be applied to the relevant target order. FIG. 9 shows an example where “∘” is stored if the relevant equipment rule or customer rule should be applied without fail to the relevant target order; “Δ” is stored when the relevant equipment rule or customer rule should be applied, if possible, to the relevant target order; and “−” is stored when the relevant equipment rule or customer rule corresponding to the relevant target order should not be applied.

Therefore, in the case of the example in FIG. 9, it is shown that in a case of an order with the order ID “D0001,” each of the equipment rules “A1” and “A2” should be applied if they are applicable (“Δ”); and the equipment rule “A3” should not be applied (“−”; that is, in the example in FIG. 9, the order is not a special ink). Furthermore, FIG. 9 shows that regarding the above-mentioned order, the customer rule “B1” should be observed strictly (“∘”) and the customer rules “B2” and “B3” should be applied if they are applicable (“Δ”).

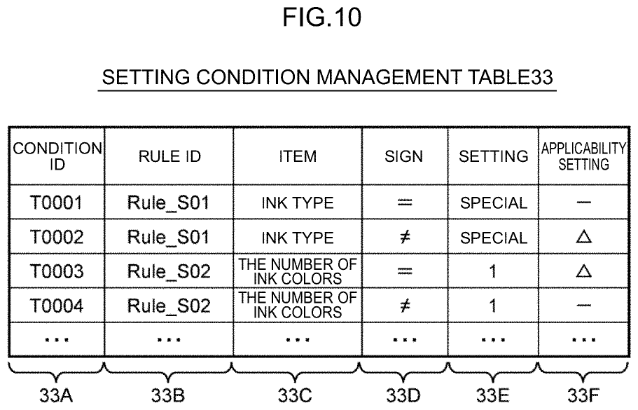

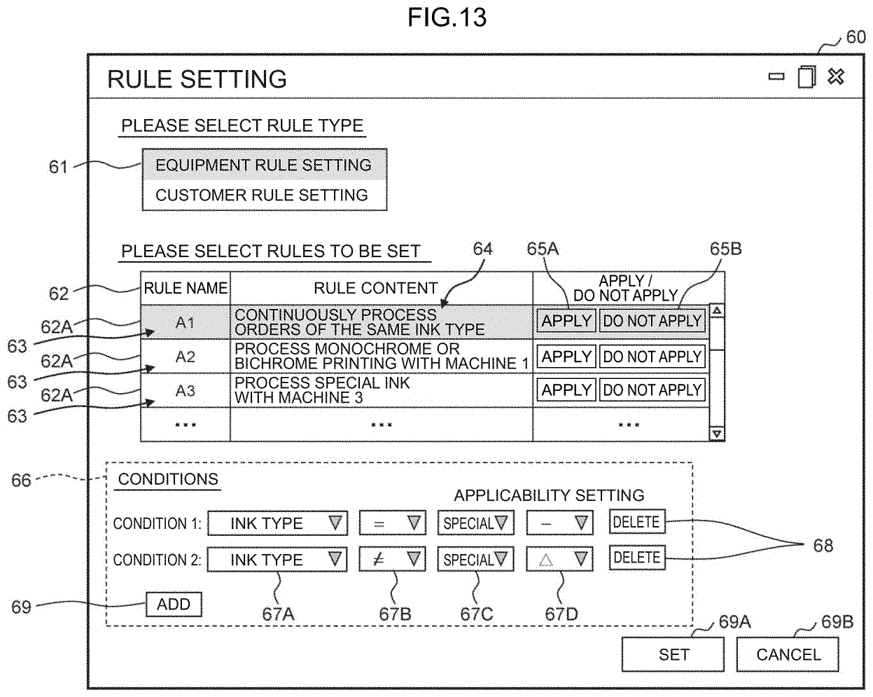

The setting condition management table 33: is a table used to manage conditions to apply the equipment rules, which are set by the work plan devising person in charge by using a rule setting screen 60 described later with reference to FIG. 13; and is configured, as illustrated in FIG. 10, by including a condition ID column 33A, a rule ID column 33B, an item column 33C, a sign column 33D, a setting column 33E, and an applicability setting column 33F. Regarding the setting condition management table 33, one row corresponds to one equipment rule.

Then, the condition ID column 33A stores a unique identifier of the relevant condition (condition ID), which is assigned to that condition; and the rule ID column 33B stores a rule ID of an equipment rule to which the relevant condition is applied. Furthermore, the item column 33C stores information indicating an item to which the relevant condition among the relevant equipment rules is applied.

The sign column 33D stores a sign indicating whether the relevant equipment rule which is set by the work plan devising person in charge by using the rule setting screen 60 should be applied or not. Regarding the above-described sign, a sign “=” is stored if the relevant condition should be applied to the relevant equipment rule; and a sign “≠” is stored if the relevant condition should not be applied to the relevant equipment rule.

Furthermore, the setting column 33E stores the relevant condition; and the applicability setting column 33F stores applicability of the relevant condition which is set by the work plan devising person in charge by using the rule setting screen 60. Specifically speaking, the applicability setting column 33F stores: “Δ” when the relevant condition should be applied to the relevant equipment rule if it is applicable; and “−” when the relevant condition does not have to be applied to the relevant equipment rule.

Therefore, in the case of the example in FIG. 10, it is shown that: a condition to which the condition ID “T0001” is assigned is a condition regarding the equipment rule with the rule ID “Rule_S01” (in the example in FIG. 7, the condition to “CONTINOUSLY PROCESS ORDERS OF THE SAME INK TYPE”); and this condition does not have to be applied (“−” in the applicability setting column) if the “INK TYPE” is “SPECIAL” (“=” in the sign column).

Moreover, in the example in FIG. 10, it is shown that: a condition to which the condition ID “T0002” is assigned is a condition regarding the equipment with the rule ID “Rule_S01”; and when the “INK TYPE” is not “SPECIAL” (“≠” in the sign column), the equipment rule with the rule ID “Rule_S01” should be applied if it is applicable (“Δ” in the applicability setting column).

### (3) Configurations of Various Kinds of Screens

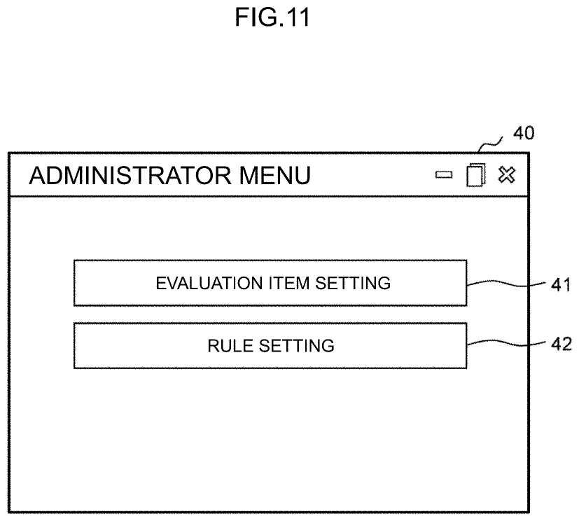

FIG. 11 illustrates an administrator menu screen 40 which is displayed on the second client terminal 7 (FIG. 1) by a specified operation. This administrator menu screen 40 is a menu screen used when the work plan devising person in charge sets necessary settings; and an evaluation item setting button 41 and a rule setting button 42 are displayed. Then, on the administrator menu screen 40, the display screen can be switched to an evaluation item setting screen 50 illustrated in FIG. 12 by clicking the evaluation item setting button 41.

This evaluation item setting screen 50 is a screen to be used by the work plan devising person in charge to designate an evaluation item to be used to devise the work plan from the respective evaluation items for the customer evaluation (such as the delivery date, the quality, and the cost), which are set respectively by the salesperson in charge with respect to each customer.

Practically, displayed on this evaluation item setting screen 50 is an evaluation item list 51 provided with rows respectively corresponding to all the evaluation items which are registered in the evaluation item management table 28 described earlier with reference to FIG. 6. Furthermore, a character string 52 indicating an item name of the relevant evaluation item and an apply button 53A and a do-not-apply button 53B are displayed in each of these rows 51A of the evaluation item list 51.

Then, the work plan devising person in charge can select the evaluation item to be used to devise the work plan from among the respective evaluation items of the customer evaluation, which are respectively set by the salesperson in charge with respect to each customer, by clicking the apply button 53A in the row 51A corresponding to that evaluation item. In this case, the relevant apply button 53A corresponding to the condition item is highlighted in a colored state so that it is possible to recognize at a glance that the condition item is selected.

Moreover, the work plan devising person in charge can cancel the selected state of the relevant condition item (to remove the relevant condition item from the evaluation item(s) to be used to devise the work plan) by clicking the do-not-apply button 53B in the row 51A corresponding to the already selected condition item. In this case, a display mode of the apply button 53A which has been highlighted is returned to its original display mode without highlight.

Then, regarding the evaluation item setting screen 50, the display screen can be returned to the administrator menu screen 40 (FIG. 11) by selecting the evaluation item to be used to devise the work plan from among the respective evaluation items whose item names are displayed on the evaluation item list 51 as described above and then clicking the return button 54 provided on the lower right of the screen; and additionally, each condition item which is then selected on the evaluation item setting screen 50 can be set as the evaluation item to be used to devise the work plan.

On the other hand, regarding the administrator menu screen 40, the display screen can be switched to, for example, a rule setting screen 60 as illustrated in FIG. 13 by clicking the rule setting button 42. This rule setting screen 60 is a screen to be used by the work plan devising person in charge to set the equipment rules and the customer rules in advance which should be applied when this work plan devising server 3 devises the work plan.

Practically, on the rule setting screen 60, a rule-type-based list 61 in which all rule types which can be then set is displayed in the upper part of the screen. In the case of this embodiment, such rule types include: equipment rules regarding the use of printing equipment during the printing work; and customer rules which are set according to orders from customers.

Then, with the rule setting screen 60, a rule setting screen which is configured to set various settings regarding the rule types is displayed by clicking a desired rule type from among the rule types listed in the rule-type-based list 61. In this case, a row corresponding to the rule type which is then selected from the rule-type-based list 61 is colored so that a user can recognize at a glance which rule type is currently selected.

Incidentally, in the case of this embodiment, the rule setting screen (hereinafter referred to as the “equipment rule setting screen”) 60 for setting the equipment rules as illustrated in this FIG. 13 is displayed as a default as the rule setting screen 60 when clicking the rule setting button 42 on the administrator menu screen 40 (FIG. 11).

Regarding this equipment rule setting screen 60, an equipment rule list 62 provided with rows 62A respectively corresponding to the respective equipment rules which are then registered in the equipment rule management table 29 (FIG. 7) is displayed below the above-mentioned rule-type-based list 61. Furthermore, a character string 63 indicating a rule name of the relevant equipment rule (“A1” to “A3” in FIG. 13), a character string 64 indicating specific content (rule content) of that equipment rule (for example, “CONTINUOUSLY PROCESS ORDERS OF THE SAME INK TYPE” in FIG. 13), an apply button 65A, and a do-not-apply button 65B are displayed in each of these rows 62A of the equipment rule list 62.

Then, the work plan devising person in charge can select a rule to be applied when devising the work plan from among the equipment rules listed in the above-described equipment rule list 62 by clicking the apply button 65A in a row 62A corresponding to that equipment rule. In this case, the apply button 65A corresponding to that equipment rule is highlighted in a colored state so that it becomes possible to recognize at a glance that the relevant condition item is selected.

Moreover, regarding the equipment rule setting screen 60, the selected state of the relevant equipment rule can be canceled (to remove that equipment rule from the equipment rules to be used to devise the work plan) by clicking the do-not-apply button 65B in the row 62A corresponding to the already selected equipment rule. In this case, the display of the apply button 65A which has been highlighted is returned to its original state without highlight.

Furthermore, regarding the equipment rule setting screen 60, a condition for applying the relevant equipment rule (applicability setting) can be set to the relevant row 62A in a condition creation area 66 provided below the equipment rule list 62 by clicking any one of the rows 62A in the equipment rule list 62.

Practically, a plurality of boxes 67A, which respectively correspond to the item column 33C, the sign column 33D, the setting column 33E, and the applicability setting column 33F of the setting condition management table 33 described earlier with reference to FIG. 10, are respectively displayed in in the above-mentioned condition creation area 66 with respect to each condition. Then, with the equipment rule setting screen 60, a character string displayed in each of these boxes 67A to 67D can be selected in a pull-down mode, so that a desired condition can be set accordingly.

Incidentally, a delete button 68 which corresponds to each condition which is then created is displayed in the condition creation area 66. Then, the relevant condition which is then created in the condition creation area 66 can be deleted (or cleared) by clicking this delete button 68.

Moreover, an add button 69 is displayed in the condition creation area 66 and a plurality of new boxes 67A to 67D, which respectively correspond to the item column 33C, the sign column 33D, the setting column 33E, and the applicability setting column 33F of the setting condition management table 33, can be displayed in the condition creation area 66 by clicking this add button 69. Consequently, the work plan devising person in charge can set a new condition(s) by using these new boxes 67A to 67D.

Then, on the equipment rule setting screen 60, these rules and conditions can be registered as the equipment rules which are set, by selecting the equipment rules to be applied is set when this work plan devising server 3 devises the work plan as described above, setting the conditions for these equipment rules (the applicability setting), and then clicking a set button 69A displayed on the lower right of the screen.

Practically, in this case, the application status column 29D of rows corresponding to the respective equipment rules selected as the rules to be applied when this work plan devising server 3 devises the work plan as described earlier, among the respective rows of the equipment rule management table 29 (FIG. 7), stores information indicating that each relevant equipment rule is applied (“APPLIED” in FIG. 7). Furthermore, the conditions regarding the respective equipment rules which are then created in the condition creation area 66 are respectively registered in the setting condition management table 33 (FIG. 10).

Moreover, regarding the equipment rule setting screen 60, by clicking a cancel button 69B displayed on the right side of the set button 69A, this equipment rule setting screen 60 can be closed without registering the rules, which are then selected by using the equipment rule setting screen 60, or the conditions created in the condition creation area 66 into the applied state.

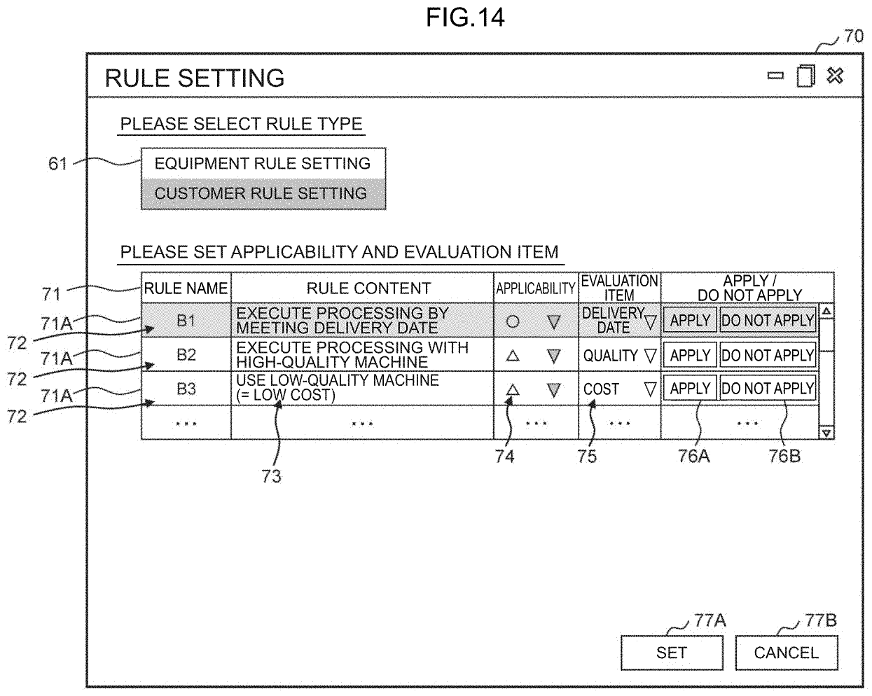

On the other hand, by clicking and selecting the row corresponding to the customer rule in the rule-type-based list 61 on the equipment rule setting screen 60, the display screen can be switched to a rule setting screen (hereinafter referred to as the “customer rule setting screen”) 70 for setting the customer rules as illustrated in FIG. 14.

On this customer rule setting screen 70, a customer rule list 71 provided with rows 71A corresponding respectively to the respective customer rules which are then registered in the customer rule management table 30 (FIG. 8) is displayed below the rule-type-based list 61. Furthermore, a character string 72 indicating a rule name of the relevant customer rule (“B1” to “B3” in FIG. 14), a character string 73 indicating specific rule content of that customer rule (for example, “EXECUTE PROCESSING BY MEETING DELIVERY DATE” in FIG. 14), a sign 74 indicating applicability (“∘” or “Δ” in FIG. 14), a character string 75 indicating an evaluation item to which the relevant customer rule is applied (for example, the “DELIVERY DATE” in FIG. 14), an apply button 76A, and a do-not-apply button 76B are displayed in each of these rows 71A in the customer rule list 71.

Then, with the customer rule list 71, the applicability regarding the individual customer rules and the target evaluation item can be selected in the pull-down mode. Furthermore, the work plan devising person in charge can select a desired rule to be applied from among the customer rules listed in the customer rule list 71 by clicking the apply button 76A in the row 71A corresponding to that customer rule. In this case, the apply button 76A corresponding to that customer rule is highlighted in a colored state so that it becomes possible to recognize at a glance that the relevant condition item is selected.

Moreover, regarding the customer rule setting screen 70, the selected state of the relevant customer rule can be canceled (to remove that customer rule from the customer rules to be used to devise the work plan) by clicking the do-not-apply button 76B in the row 71A corresponding to the already selected customer rule. In this case, the display mode of the apply button 76A which has been highlighted is returned to its original state without highlight.

Then, on the customer rule setting screen 70, these customer rules can be registered as the customer rules which are set, by: selecting the customer rules to be applied when this work plan devising server 3 devises the work plan as described earlier; selecting the applicability and the evaluation items with regard to these customer rules; and then clicking a set button 77A displayed on the lower right of the screen.

Practically, in this case, the priority column 30D and the evaluation item name column 30E of a row corresponding to each customer rule selected as the rule to be applied when this work plan devising server 3 devises the work plan as described earlier, among the respective rows of the customer rule management table 30 (FIG. 8), store information about the applicability and the evaluation item respectively selected by the user in the customer rule list 71. Furthermore, the application status column 30F of these rows stores information indicating that the relevant customer rule is applied (“APPLIED” in FIG. 8).

Moreover, regarding the customer rule setting screen 70, by clicking a cancel button 77B displayed on the right side of the set button 77A, this customer rule setting screen 70 can be closed without registering the rules, which are then selected by using the customer rule setting screen 70, into the applied state.

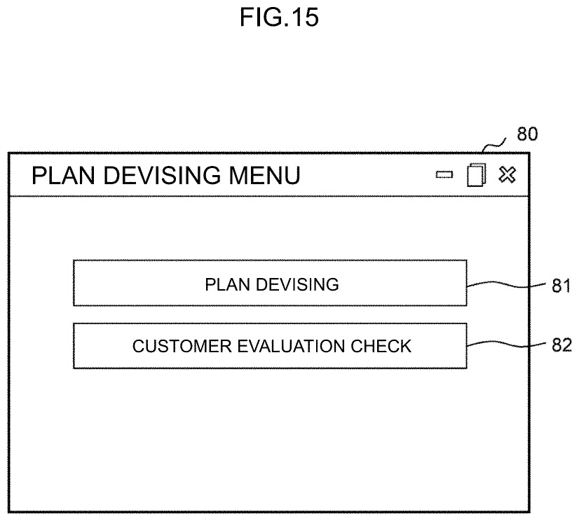

Meanwhile, FIG. 15 illustrates a plan devising menu screen 80 which is displayed on the second client terminal 7 (FIG. 1) by a specified operation. This plan devising menu screen 80 is a menu screen used by the work plan devising person in charge when actually devising the work plan; and a plan devising button 81 and a customer evaluation check button 82 are displayed.

Then, the work plan devising person in charge can switch the display screen to the plan devising screen 90 illustrated in FIG. 16 by clicking the plan devising button 81 on the plan devising menu screen 80. On this plan devising screen 90, a first date text box 91A and a first time text box 91B for designating, respectively, a starting day and starting time of a time period during which the work plan devising server 3 should devise the work plan (hereinafter referred to as the “designated plan devising period”), and a second date text box 92A and a second time text box 92B for designating, respectively, an ending day and ending time of the designated plan devising period.

Consequently, the work plan devising person in charge can designate the designated plan devising period by inputting the starting day of the designated plan devising period to the first date text box 91A, causing the starting time of the designated plan devising period to be displayed in the first time text box 91 B in the pull-down mode, and further inputting the ending day of the designated plan devising period in the second date text box 92A, selecting the ending time of the designated plan devising period in the pull-down mode, and causing the selected ending time to be displayed in the second time text box 92B.

Incidentally, calendars 93A, 93B are displayed in the plan devising screen 90 by making the calendars 93A, 93B correspond to the first and second date text boxes 91A, 92A, respectively; and by clicking dates corresponding to the starting day and the ending day of the designated plan devising period in these calendars 93A, 93B, these dates can be designated as the starting day and the ending day of the designated plan devising period. In this case, the date designated on the calendar is displayed in the corresponding first or second date text box 91A, 92A.

Then, the work plan devising person in charge can cause this work plan devising server 3 to execute work plan devising processing for devising the work plan during the designated plan devising period by designating the starting day and the starting time and the ending day and the ending time of the designated plan devising period in the plan devising screen 90 as described above and then clicking the plan devising execution button 94.

Practically, after the plan devising execution button 94 is clicked, the work plan devising server 3 acquires the order information of all orders, for which the work should be conducted within the designated plan devising period, respectively from the order information registered in the order management table 16 (FIG. 2) of the customer management server 2 (FIG. 1). Furthermore, the work plan devising server 3 refers to the equipment rule management table 29 and the customer rule management table 30, checks the equipment rules and the customer rules which should then be applied (the equipment rules and the customer rules regarding which “APPLIED” is stored in the application status columns 29D, 30F), and acquires all the conditions for necessary equipment rules from the setting condition management table 33. Then, the work plan devising server 3 executes the work plan devising processing for devising the work plan within the designated plan devising period on the basis of each information thus acquired and causes the second client terminal 7 to display the work plan devised by this work plan devising processing as a devised plan result display screen 100 illustrated in FIG. 17.

This devised plan result display screen 100 is a screen for displaying the work plan, which is devised by the aforementioned work plan devising processing and designated in the plan devising screen 90 described above with reference to FIG. 16, within the designated plan devising period; and a devised plan result Gantt chart 101 is displayed on the left side of the screen and a rule satisfaction status details list tab 102 is displayed on the right side of the screen.

Then, the devised plan result Gantt chart 101 displays a work plan for each printing machine within the designated plan devising period, which is devised by the aforementioned work plan devising processing, as a bar graph. More specifically, the devised plan result Gantt chart 101 displays bar graphs 101A, each of which indicates from what time to what time each printing machine should execute printing processing for which order; and an order ID of the relevant order is displayed in that bar graph 101A.

Moreover, in the devised plan result Gantt chart 101, an icon in the shape of “Δ” (hereinafter referred to as the “icon Δ”) 101B is displayed in a prominent color such as orange regarding an order which does not satisfy the acceptable rules (mainly the equipment rules such as “CONTINUOUSLY PROCESS ORDERS OF THE SAME INK TYPE” and “WHICH MACHINE TO BE USED FOR MONOCHROME OR BICHROME PRINTING”), at the right end of the bar graph 101A corresponding to that order. Furthermore, in the devised plan result Gantt chart 101, an icon in the shape of “×” (hereinafter referred to as the “icon ×”) 101C is displayed in a color such as red, which is more prominent than that of the icon Δ 101B, regarding an order which does not satisfy the rules to be strictly observed (mainly the customer rules such as the delivery date, the quality and the cost which were demanded when the order was placed), at the right end of the bar graph 101A corresponding to that order.

Moreover, the rule satisfaction status details list tab 102 is provided with rows 102A corresponding to the respective orders regarding which the bar graphs 101A are displayed in the devised plan result Gantt chart 101 (the respective orders which should be processed within the designated plan devising period); and these rows 102A are divided into a plurality of rule satisfaction status columns 102B respectively corresponding to the equipment rules and the customer rules which are set on the equipment rule setting screen 60 (FIG. 13) and the customer rule setting screen 70 (FIG. 14)

Then, a mark indicating whether or not the relevant order satisfies the relevant equipment rule or customer rule (hereinafter referred to as the “rule satisfaction status mark”) 102C is displayed in each of these rule satisfaction status columns 102B. Incidentally, FIG. 17 shows an example where any one of the following marks is stored as the above-described rule satisfaction status mark 102C: “∘” if the relevant order satisfies the relevant equipment rule or customer rule; “Δ” if the relevant order does not satisfy the relevant acceptable equipment rule or customer rule; “×” if the relevant order does not satisfy the relevant equipment rule or customer rule; and “−” if the relevant equipment rule or customer rule is not applied.

Furthermore, regarding the rule satisfaction status column 102B in which “×” is stored in the rule satisfaction status details list tab 102, if the rule which is not satisfied is the rule which should be observed, it is colored with the same color as that of the icon × 101C in the devised plan result Gantt chart 101; and if the rule which is not satisfied is the rule whose non-satisfaction is acceptable, it is colored with the same color as that of the icon Δ 101B in the devised plan result Gantt chart 101.

Consequently, the work plan devising person in charge can check the work plan(s) devised by this work plan devising server 3 on the basis of the devised plan result Gantt chart 101 on this devised plan result display screen 100. Furthermore, the work plan devising person in charge can easily recognize the order(s) which does not satisfy the rules in the work plan and the rules which are not satisfied with regard to the relevant order(s) on the basis of the icon × 101C and the icon Δ 101B, which are displayed in the devised plan result Gantt chart 101, and the rule satisfaction status details list tab 102.

Moreover, on the devised plan result display screen 100, a Gantt chart of a work plan(s) which is redevised in consideration of the customer evaluation (hereinafter referred to as the “optimization Gantt chart”) 104 as illustrated in FIG. 18 can be displayed below the devised plan result Gantt chart 101 by clicking an optimization button 103 which is displayed in the middle on the left side of the screen. The display mode of the optimization Gantt chart 104 is similar to that of the devised plan result Gantt chart 101, so that any explanation about it is omitted here.

Moreover, under this circumstance, a rule satisfaction status details (after optimization) list tab 105 corresponding to the work plan which is redevised in consideration of the customer evaluation is displayed, instead of the rule satisfaction status details list tab 102, on the right side of the screen. The configuration and display mode of this rule satisfaction status details (after optimization) list tab 105 are similar to those of the rule satisfaction status details list tab 102, so that any detailed explanation about them is omitted here.

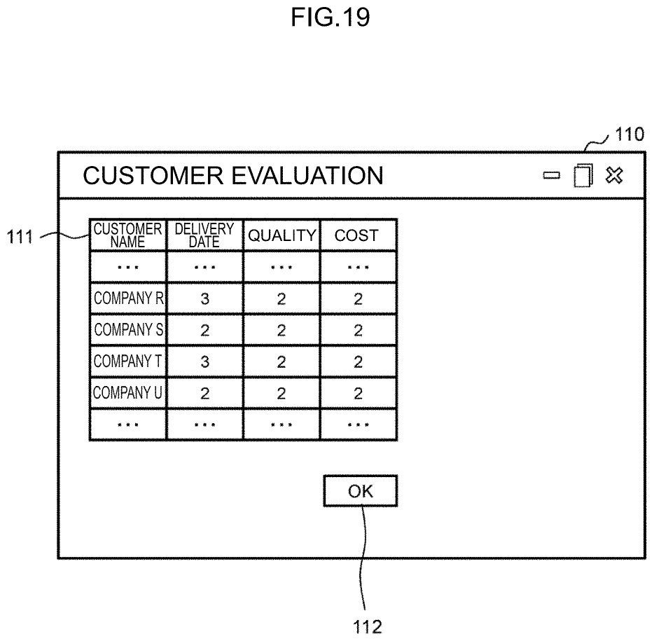

On the other hand, a customer evaluation display screen 110 as illustrated in FIG. 19 can be displayed on the second client terminal 7 by clicking the customer evaluation check button 82 on the plan devising menu screen 80 (FIG. 15).

A customer evaluation list 111 is displayed on this customer evaluation display screen 110. Then, this customer evaluation list 111 displays the customer evaluation of each customer registered in the customer evaluation management table 31 (FIG. 1), which is updated as appropriate by learning as described later. The customer evaluation display screen 110 can be closed by clicking an OK button 112 which is displayed at the bottom of the screen.

### (4) Various Kinds of Processing Related to Work Plan Devising Function

Next, an explanation will be provided about specific processing content of various kinds of processing executed by the work plan devising server 3 in association with the aforementioned work plan devising function. Incidentally, a processing subject of the various kinds of processing will be hereinafter explained as a “program”; however, practically, it is needless to say that the CPU 20 (FIG. 1) for the work plan devising server 3 executes the processing on the basis of that “program.”

### (4-1) Rule Setting Processing

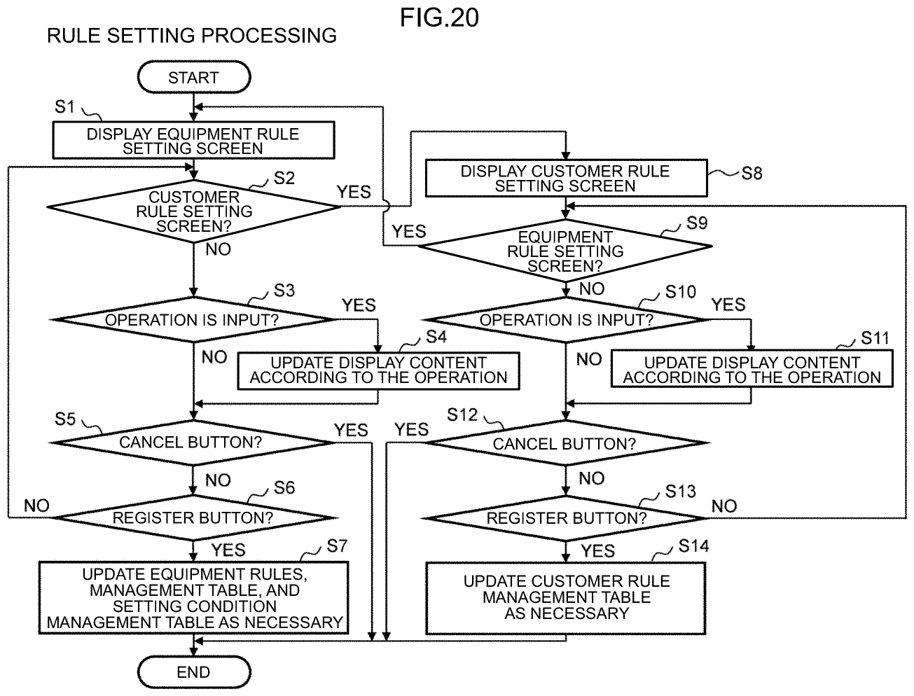

FIG. 20 illustrates rule setting processing executed by the rule setting processing program 23 (FIG. 1) for the work plan devising server 3 when the rule setting button 42 on the administrator menu screen 40 described earlier with reference to FIG. 11 is clicked. The rule setting processing program 23 causes the equipment rule setting screen 60 (FIG. 13) and the customer rule setting screen 70 (FIG. 14) to be displayed on the second client terminal 7 in accordance with the processing sequence illustrated in this FIG. 20 and updates the equipment rule management table 29 (FIG. 7) and the customer rule management table 30 (FIG. 8) on the basis of the equipment rules and the customer rules, which are set by the work plan devising person in charge by using the equipment rule setting screen 60 and the customer rule setting screen 70, and registers the conditions for the respective equipment rules, which are set by using the equipment rule setting screen 60, in the setting condition management table 33.

Practically, when the rule setting button 42 (FIG. 11) on the administrator menu screen 40 (FIG. 11) displayed on the second client terminal 7 is clicked, the rule setting processing program 23 starts this rule setting processing and firstly causes the equipment rule setting screen 60 described earlier with reference to FIG. 13, instead of the administrator menu screen 40, to be displayed on the second client terminal 7 (S1).

Subsequently, the rule setting processing program 23 waits for the customer rules to be selected in the rule-type-based list 61 on the equipment rule setting screen 60, for whatever operation other than clicking on the set button 69A or the cancel button 69B to be performed on the equipment rule setting screen 60, or for the set button 69A or the cancel button 69B to be clicked (S2, S3, S5, S6-S2).

Then, if any operation other than clicking on the set button 69A or the cancel button 69B is performed (S3; YES), the rule setting processing program 23 updates the equipment rule setting screen 60 as appropriate according to that operation (S4).

Moreover, if the cancel button 69B is clicked (S5; YES), the rule setting processing program 23 discards all the equipment rules and the customer rules which have been set on the equipment rule setting screen 60 and the customer rule setting screen 70 by the work plan devising person in charge, then closes the equipment rule setting screen 60, and terminates this rule setting processing.

On the other hand, if the set button 69A is clicked (S6; YES), the rule setting processing program 23 updates the equipment rule management table 29 (FIG. 7) and the customer rule management table 30 (FIG. 8) in accordance with all the equipment rules and the customer rules, which have been set on the equipment rule setting screen 60 and the customer rule setting screen 70 by the work plan devising person in charge, and registers necessary conditions in the setting condition management table 33 (FIG. 10), and then closes this equipment rule setting screen 60 (S7). Subsequently, the rule setting processing program 23 terminates this rule setting processing.

On the other hand, if the customer rules are selected in the rule-type-based list 61 (FIG. 13) on the equipment rule setting screen 60 (S2; YES), the rule setting processing program 23 switches the display screen of the second client terminal 7 to the customer rule setting screen 70 described earlier with reference to FIG. 14 (S8).

Then, the rule setting processing program 23 wait for the equipment rules to be subsequently selected in the rule-type-based list 61 on the customer rule setting screen 70, for whatever operation other than clicking on the set button 77A or the cancel button 77B to be performed on the customer rule setting screen 70, or for the set button 77A or the cancel button 77B to be clicked (S9, S10, S12, S13-S9).

Then, if the equipment rules are selected in the rule-type-based list 61 on the customer rule setting screen 70 (S9; YES), the rule setting processing program 23 switches the display screen of the second client terminal 7 to the equipment rule setting screen 60 described earlier with reference to FIG. 13 (51) and then executes the processing in step 51 and subsequent steps in the same manner as described above.

Moreover, if any operation other than clicking on the set button 77A or the cancel button 77B is performed (S10; YES), the rule setting processing program 23 updates the customer rule setting screen 70 as appropriate according to that operation (S11).

Furthermore, if the cancel button 77B is clicked (S12; YES), the rule setting processing program 23 discards all the equipment rules and the customer rules which have been set on the equipment rule setting screen 60 and the customer rule setting screen 70 by the work plan devising person in charge, then closes this the customer rule setting screen 70, and terminates this rule setting processing.

On the other hand, if the set button 77A is clicked (S13; YES), the rule setting processing program 23 updates the equipment rule management table 29 (FIG. 7) and the customer rule management table 30 (FIG. 8) in accordance with all the equipment rules and the customer rules, which have been set on the equipment rule setting screen 60 and the customer rule setting screen 70 by the work plan devising person in charge, and registers necessary conditions in the setting condition management table 33 (FIG. 10), and then closes this customer rule setting screen (S14). Subsequently, the rule setting processing program 23 terminates this rule setting processing.

### (4-2) Work Plan Devising Processing

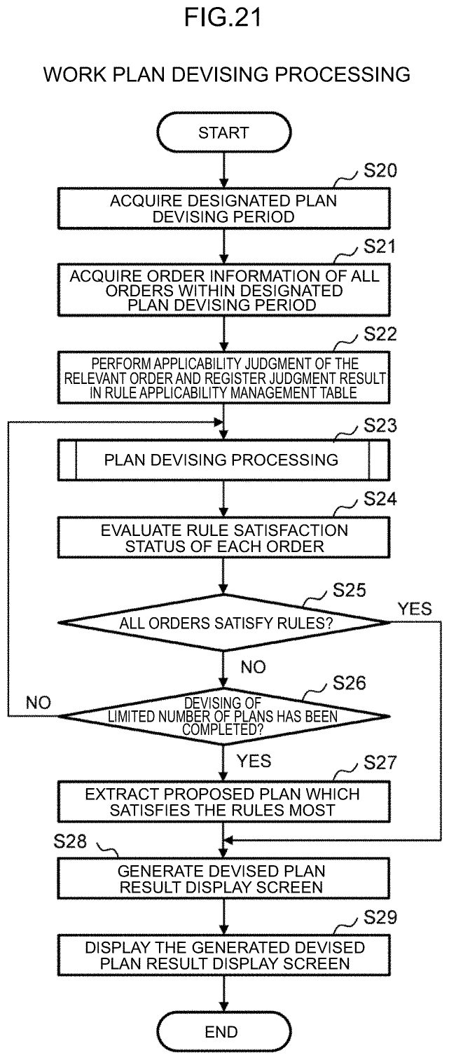

Meanwhile, FIG. 21 illustrates work plan devising processing executed by the plan devising processing program 24 of the work plan devising server 3 when the plan devising execution button 94 in the plan devising screen 90 described earlier with reference to FIG. 16 is clicked. The plan devising processing program 24 devises a work plan within the designated plan devising period in accordance with an order from the customer and, for example, the equipment rules and the customer rules, which are set by the work plan devising person in charge, according to the processing sequence illustrated in this FIG. 21.

Practically, if the designated plan devising period is set on the plan devising screen 90 and the plan devising execution button 94 is clicked, the plan devising processing program 24 starts the work plan devising processing illustrated in this FIG. 21 and firstly acquires the designated plan devising period which is set on the plan devising screen 90 (S20).

Subsequently, the plan devising processing program 24 accesses the customer management server 2 and acquires the order information of all orders which should be processed within the designated plan devising period, among the orders whose order information is stored in the order management table 16 (FIG. 2) of that customer management server 2 (S21).

Next, the plan devising processing program 24 judges the applicability of each equipment rule and each customer rule with respect to each of these orders on the basis of the order information of each order acquired in step S21 and registers the judgment result in the rule applicability management table 32 (FIG. 9) (S22).

For example, if “A1” to “A3” in FIG. 13 are set as the equipment rules and “B1” to “B3” in FIG. 14 are set as the customer rules, and if the order is not for printing with a special ink, the plan devising processing program 24 determines that the equipment rule “A1” should be applied as much as possible and stores “∘” or “Δ” in the relevant applicability column 32B (FIG. 9) of the rule applicability management table 32; and if the order is to print with the special ink, the plan devising processing program 24 determines that the equipment rule “A1” should not be applied and stores “−” in the relevant applicability column 32B of the rule applicability management table 32.

Moreover, if the order is for monochrome or bichrome printing, the plan devising processing program 24 determines that the equipment rule “A2” should be applied as much as possible, and stores “∘” or “Δ” in the relevant applicability column 32B of the rule applicability management table 32; and if the order is for printing with three or more colors, the plan devising processing program 24 determines that the equipment rule “A2” should not be applied and stores “−” in the relevant applicability column 32B of the rule applicability management table 32.

Furthermore, if the order is not for printing with the special ink, the plan devising processing program 24 determines that the equipment rule “A3” should not be applied and stores “−” in the relevant applicability column 32B of the rule applicability management table 32; and if the order is for printing with the special ink, the plan devising processing program 24 determines that the equipment rule “A3” should be applied, and stores “∘” or “Δ” in the relevant applicability column 32B of the rule applicability management table 32.

Furthermore, regarding the customer rules “B1” to “B3,” the plan devising processing program 24 stores the applicability (“∘,” “Δ,” or “Δ”), which is set to each of “B1” to “B3” by the work plan devising person in charge on the customer rule setting screen 70 (FIG. 14), in the relevant applicability column 32B of the rule applicability management table 32.

Subsequently, the plan devising processing program 24 executes the plan devising processing for devising the work plan within the designated plan devising period on the basis of the rule applicability management table 32 in which the applicability judgment is registered in step S22 (S23). Specific content of the plan devising processing will be explained later.

Next, with regard to each order for which a work schedule is created in the work plan devised in step S23, the plan devising processing program 24 evaluates whether or not the work schedule of that order satisfies each equipment rule and each customer rule which are set by the work plan devising person in charge (S24).

Specifically speaking, the plan devising processing program 24 prepares a chart which is not illustrated in the drawing and has the same configuration as that of the rule satisfaction status details list tab 102 of the devised plan result display screen 100 described earlier with reference to FIG. 17 (hereinafter referred to as the “rule satisfaction status details chart”), on the main storage apparatus 21 (FIG. 1); and if the work schedule of the relevant order satisfies the equipment rule or the customer rule, the plan devising processing program 24 stores “∘” in the corresponding column of the rule satisfaction status details chart.

Moreover, if the work schedule of the relevant order does not satisfy the equipment rule or the customer rule and if that equipment rule or customer rule is a rule which should be observed (the rule with “∘” in the rule applicability management table 32), the plan devising processing program 24 stores “×” in the corresponding column of the rule satisfaction status details chart.

Furthermore, if the work schedule of the relevant order does not satisfy the equipment rule or the customer rule and if that equipment rule or customer rule is a rule regarding which it is acceptable even if that equipment rule or customer rule is not observed (the rule with “Δ” in the rule applicability management table 32), the plan devising processing program 24 stores “Δ” in the corresponding column of the rule satisfaction status details chart.

Subsequently, the plan devising processing program 24 judges, on the basis of the evaluation result in step S24, whether or not all the orders for which work schedules are made in the work plan devised in S23 respectively satisfy each equipment rule and each customer rule (S25).

If the plan devising processing program 24 obtains an affirmative result in this judgment, it proceeds to step S28; and if the plan devising processing program 24 obtains a negative result, it judges whether or not it has finished devising a predetermined specified number of (for example, three) work plans (S26). Then, if the plan devising processing program 24 obtains a negative result in this judgment, it returns to step S23 and then repeats the processing from step S23 to step S26 until it obtains an affirmative result in step S25 or step S26.

Then, if the plan devising processing program 24 eventually obtains an affirmative result in step S26 by finishing devising the predetermined specified number of work plans, it extracts the work plan with the largest number of “∘” in the rule satisfaction status details chart from the specified number of work plans devised as described above (S27).

Moreover, if the plan devising processing program 24 obtains the affirmative result in step S25 and proceeds to step S28, it generates the devised plan result display screen 100 (FIG. 17) whose content is the work plan devised in immediately preceding step S23; and if the plan devising processing program 24 obtains the affirmative result in step S26 and proceeds to step S28, it generates the devised plan result display screen 100 (FIG. 17) whose content is the work plan devised in step S27 (S28).

Under this circumstance, regarding an order for which any one of the equipment rules or the customer rules is “×” in the rule satisfaction status details chart, the plan devising processing program 24 causes the icon x 101C to be displayed at the right end of a bar graph 101A corresponding to that order in the devised plan result Gantt chart 101 (FIG. 17) of the generated devised plan result display screen 100. Furthermore, regarding an order for which any one of the equipment rules or the customer rules is “Δ” in the rule satisfaction status details chart, the plan devising processing program 24 causes the icon Δ 101B to be displayed at the right end of a bar graph 101A corresponding to that order in the devised plan result Gantt chart 101 of the generated devised plan result display screen 100.

Furthermore, the plan devising processing program 24 creates the rule satisfaction status details list tab 102 (FIG. 17) of the devised plan result display screen 100 by, so to speak, copying the rule satisfaction status details chart and colors each rule satisfaction status column 102B corresponding to a field with “Δ” or “×” in the rule satisfaction status details chart in each rule satisfaction status column 102B (FIG. 17) in the relevant rule satisfaction status details list tab 102 by using each corresponding color.

Then, the plan devising processing program 24 causes the second client terminal 7 to display the thus-created devised plan result display screen 100 (S29) and then terminates this work plan devising processing.

### (4-3) Plan Optimization Processing

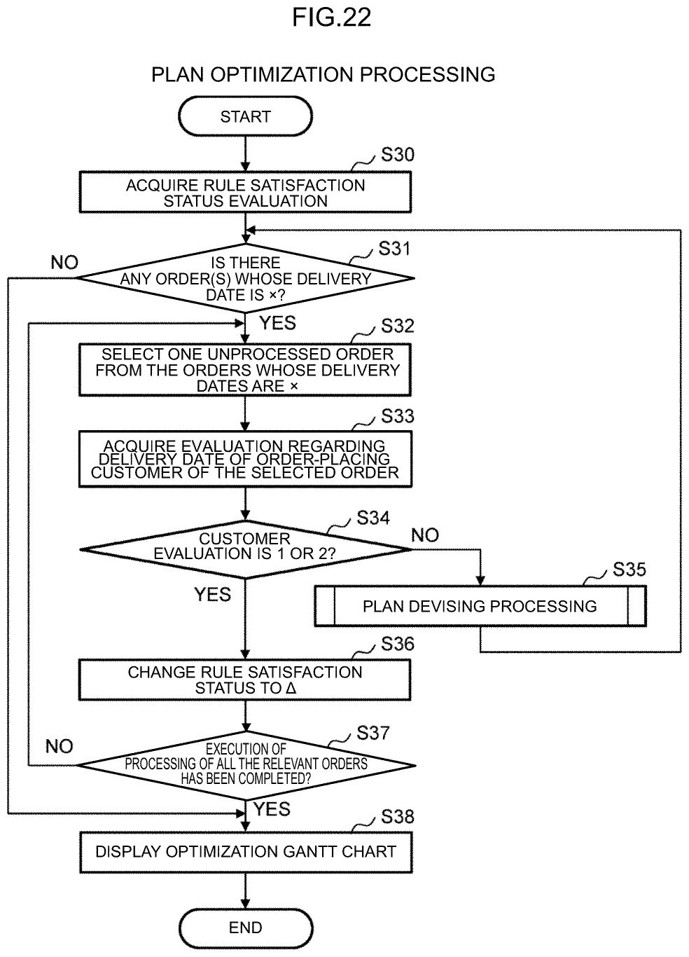

FIG. 22 illustrates a processing sequence for plan optimization processing executed by the plan optimization processing program 25 (FIG. 1) when the optimization button 103 (FIG. 17) on the devised plan result display screen 100 described earlier with reference to FIG. 17 is clicked. The plan optimization processing program 25 redevises the work plan in consideration of the customer evaluation in accordance with the processing sequence illustrated in this FIG. 22.

Practically, when the optimization button 103 on the devised plan result display screen 100 is clicked, the plan optimization processing program 25 starts the plan optimization processing illustrated in this FIG. 22 and firstly acquires the evaluation on whether or not the work schedule of each order which is stored in the rule satisfaction status details list tab 102 (FIG. 17) of the devised plan result display screen 100 satisfies each equipment rule and each customer rule which are set by the work plan devising person in charge (S30). Specifically speaking, the plan optimization processing program 25 reads the rule satisfaction status details chart which is created on the main storage apparatus 21 (FIG. 1) by the plan devising processing program 24 described earlier about step S24 in FIG. 21.

Subsequently, the plan optimization processing program 25 judges whether or not there is any order with “×” as the satisfaction status regarding the delivery date as the customer rule in the rule satisfaction status details chart which was read in step S30 (S31). Then, if the plan optimization processing program 25 obtains a negative result in this judgment, it proceeds to step S38.

On the other hand, if the plan optimization processing program 25 obtains an affirmative result in the judgment of step S31, it selects one order regarding which the processing of step S33 and subsequent steps has not been executed yet, from the orders which were detected in step S31 and whose satisfaction status of the delivery date is “×” (S32).

Subsequently, the plan optimization processing program 25 acquires the customer evaluation regarding the delivery date of a customer who placed the order selected in step S32 (hereinafter referred to as the “selected order”), from the customer evaluation management table 31 (FIG. 1) (S33). Then, the plan optimization processing program 25 judges whether the customer evaluation acquired in step S33 is “1” or “2” (S34).

To obtain a negative result in this judgment

means that the evaluation regarding the delivery date from the customer who placed the selected order is “3” which is the lowest evaluation and that it is necessary to redevise the work plan to strictly meet that customer's delivery date in order to enhance this customer evaluation. Consequently, under this circumstance, the plan optimization processing program 25 issues a command the plan devising processing program 24 (FIG. 1) to execute the plan devising processing for redevising the work plan within the designated plan devising period (S35). Then, when this plan devising processing terminates, the plan optimization processing program 25 returns to step S31 and then executes the processing in step S31 and subsequent steps in the same manner as described earlier.

On the other hand, to obtain an affirmative result in the judgment of step S34 means that the evaluation regarding the delivery date from the customer who placed the selected order is normal or higher. Consequently, under this circumstance, the plan optimization processing program 25 changes the rule satisfaction status mark 102C, which is stored in the column corresponding to the “delivery date” of the selected order in the aforementioned rule satisfaction status details chart, from “×” to “Δ” (S36).

Subsequently, the plan optimization processing program 25 judges whether the execution of the processing in step S33 and subsequent steps has been completed or not, with respect to all the orders which were detected in step S31 and have “×” as the satisfaction status of the delivery date (S37). Then, if the plan optimization processing program 25 obtains a negative result in this judgment, it returns to step S32 and then repeats the processing from step S32 to step S37 by sequentially switching the order to be selected in step S32 to another order regarding which the processing of step S33 and subsequent steps has not been executed yet.

Furthermore, if the plan optimization processing program 25 eventually obtains an affirmative result in step S37 by finishing executing the processing of step S33 to step S36 with respect to all the orders with “×” as the satisfaction status of the delivery date, it displays the optimization Gantt chart 104 (FIG. 18) according to the content of the redevised work plan below the devised plan result Gantt chart 101 on the devised plan result display screen 100 and also displays the rule satisfaction status details (after optimization) list tab 105 (FIG. 18), in which the content of the rule satisfaction status details chart at that time is copied, on the right side of the devised plan result display screen 100 (S38). Subsequently, the plan optimization processing program 25 terminates this plan optimization processing.

### (4-4) Plan Devising Processing

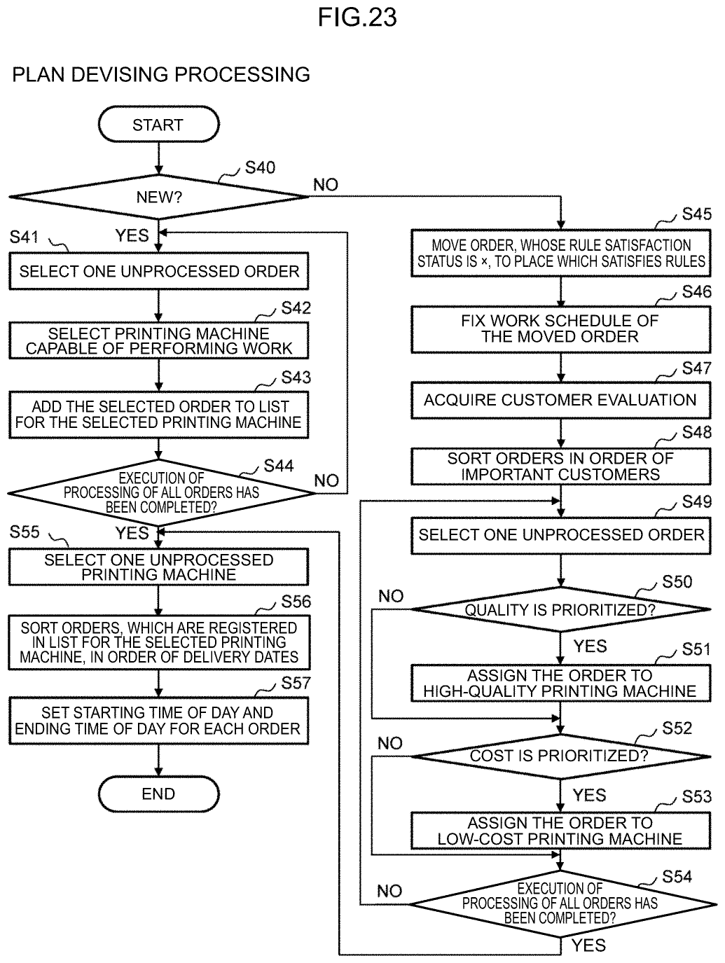

FIG. 23 illustrates specific processing content of the plan devising processing executed by the plan devising processing program 24 in step S23 of the work plan devising processing described earlier with reference to FIG. 21 and in step S35 of the plan optimization processing described earlier with reference to FIG. 22.

When the plan devising processing program 24 proceeds to step S23 of the work plan devising processing or receives the command from the plan optimization processing program 25 to execute the plan devising processing in step S35 of the plan optimization processing, it starts the plan devising processing illustrated in this FIG. 23 and firstly judges whether a work plan is to be newly devised or not (S40).

The word “newly” used here means that it is not redevising of the work plan. Therefore, if the plan devising processing program 24 proceeds to step S23 of the work plan devising processing and thereby starts this plan devising processing, this means that the plan devising processing program 24 obtains an affirmative result in this step S40.

Then, in this case, the plan devising processing program 24 selects one order regarding which the processing of step S42 and subsequent steps has not been executed yet, from all the orders for which the order information was acquired in step S21 of the work plan devising processing and the work should be conducted within the designated plan devising period (S41).

Subsequently, the plan devising processing program 24 refers to the machine management table 27 (FIG. 5) and the rule applicability management table 32 (FIG. 9) and selects one printing machine capable of printing the order selected in step S41 (this order will be hereinafter referred to as the “selected order” in the explanation of the plan devising processing) (S42). Furthermore, the plan devising processing program 24 adds and registers the selected order, which was selected in step S41, to a print target order list corresponding to the printing machine selected in step S42 from among print target order lists which are not illustrated in the drawings and are prepared in the main storage apparatus 21 (FIG. 1) by associating these print target order lists with the respective printing machines registered in the machine management table 27 (S43).

Next, the plan devising processing program 24 judges whether the execution of the processing of step S42 and subsequent steps has been completed or not with respect to all the orders which should be processed within the designated plan devising period (S44). Then, if the plan devising processing program 24 obtains a negative result in this judgment, it returns to step S41 and then repeats the processing from step S41 to step S44 by sequentially switching the order to be selected in step S41 to another relevant order which has not been processed (the order which should be processed within the designated plan devising period).

Then, if the plan devising processing program 24 eventually obtains an affirmative result in step S44 by finishing registering all the orders, which should be processed within the designated plan devising period, in the print target order list for any one of the printing machines, it selects one printing machine regarding which the processing of step S56 and subsequent steps has not been executed yet, from the respective printing machines registered in the machine management table 27 (S55).

Subsequently, the plan devising processing program 24 sorts the orders, which are registered in the print target order list corresponding to the printing machine selected in step S55, in the order of their delivery dates (S56). Furthermore, the plan devising processing program 24 calculates time required for the printing work with respect to each of the sorted orders in step S56 and sets starting time of day and ending time of day of each of these orders (S57). Subsequently, the plan devising processing program 24 terminates this plan devising processing.

On the other hand, if the plan devising processing program 24 receives the command from the plan optimization processing program 25 to execute the plan devising processing in step S35 of the plan optimization processing and thereby starts this plan devising processing, this means that the plan devising processing program 24 obtains a negative result in the judgment of step S40.

In this case, the plan devising processing program 24 moves each order regarding which the icon × 101C (FIG. 17) is displayed in the devised plan result Gantt chart 101 (FIG. 17) on the devised plan result display screen 100 (FIG. 17), to any one of positions in the devised plan result Gantt chart 101 where all the customer rules requested upon the placement of that order are satisfied (S45).

Subsequently, the plan devising processing program 24 fixes a work schedule for each order moved in step S45 to a work schedule according to that position (the printing machine, and the starting time of day and the ending time of day) (S46) and then acquires the customer evaluation information of the customer who placed each order which should be processed within the designated plan devising period, from the customer evaluation management table 31 (FIG. 1) (S47).

Next, the plan devising processing program 24 refers to the customer evaluation management table 31 (FIG. 1) and sorts the respective orders regarding which the customer evaluation information was acquired in step S47 (the respective remaining orders which should be processed within the designated plan devising period), in the order of important customers (S48).

Furthermore, the plan devising processing program 24: selects an order of the highest sort rank regarding which the processing of step S50 and subsequent steps has not been executed yet, from the sorted orders (S49); and judges whether or not the selected order should be processed by prioritizing the quality from the viewpoint of the customer evaluation of the customer who placed the selected order (S50). Under this circumstance, the plan devising processing program 24 judges whether the customer evaluation regarding the quality is “3” or not. Then, if the plan devising processing program 24 obtains a negative result in the judgment of step S50, it proceeds to step S52.

On the other hand, if the plan devising processing program 24 obtains an affirmative result in the judgment of step S50, it determines that the quality should be prioritized because the customer evaluation of that customer regarding the quality is low. Consequently, under this circumstance, the plan devising processing program 24: extracts a printing machine corresponding to high-quality printing from among the printing machines registered in the machine management table 27 (FIG. 5) in accordance with the rule “to prioritize the quality” which is an expansion of the equipment rules and the customer rules on the basis of such customer evaluation; and assigns that order to the extracted printing machine (S51). Specifically speaking, the plan devising processing program 24 adds and registers the order selected in step S49 to a print target order list corresponding to the high-quality printing machine from among the aforementioned print target order lists prepared in the main storage apparatus 21 (FIG. 1) by associating these print target order lists with the respective printing machines registered in the machine management table 27.

Subsequently, the plan devising processing program 24 judges whether or not the order selected in step S49 should be processed by prioritizing the cost from the viewpoint of the customer evaluation of the customer who placed the selected order (S52). Under this circumstance, the plan devising processing program 24 judges whether the customer evaluation regarding the cost is “3” or not. Then, if the plan devising processing program 24 obtains a negative result in the judgment of step S52, it proceeds to step S54.

On the other hand, if the plan devising processing program 24 obtains an affirmative result in the judgment of step S52, it determines that the cost should be prioritized because the customer evaluation of that customer regarding the cost is low. Consequently, under this circumstance, the plan devising processing program 24: extracts a printing machine which would make the cost inexpensive, from among the printing machines registered in the machine management table 27 (FIG. 5) in accordance with the rule “to prioritize the cost” which is an expansion of the equipment rules and the customer rules on the basis of such customer evaluation; and assigns that order to the extracted printing machine (S53). Specifically speaking, the plan devising processing program 24 adds and registers the order selected in step S49 to a print target order list corresponding to the printing machine which would make the cost inexpensive, from among the aforementioned print target order lists prepared in the main storage apparatus 21 (FIG. 1) by associating these print target order lists with the respective printing machines registered in the machine management table 27.

Subsequently, the plan devising processing program 24 judges whether the execution of the processing of step S50 and subsequent steps has been completed or not with respect to all the target orders (the respective orders regarding which the customer evaluation of the relevant customer was acquired in step S47) (S54). Then, if the plan devising processing program 24 obtains a negative result in this judgment, it retains to step S49 and then repeats the processing from step S49 to step S54 by switching the order to be selected in step S49 to another order regarding which the customer evaluation was acquired in step S47 and the processing of step S50 and subsequent steps has not been executed yet.

Then, if the plan devising processing program 24 eventually obtain an affirmative result in step S54 by finishing executing the processing of step S50 and subsequent steps with respect to all the orders regarding which the customer evaluation was acquired in step S47, the plan devising processing program 24 subsequently assigns each of the target orders to any one of the printing machines and sets the starting time of day and the ending time of day of the print work to each of the target orders by executing the processing from step S55 to step S57 in the same manner as described earlier, and then terminates this plan devising processing.

### (4-5) First Evaluation Learning Processing

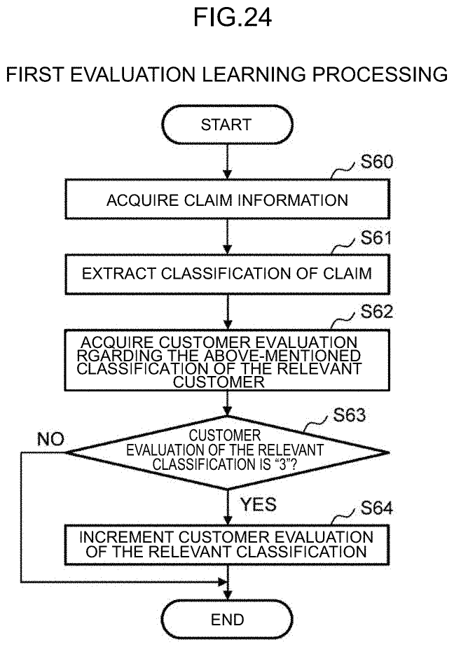

FIG. 24 illustrates a processing sequence for first evaluation learning processing executed by the evaluation learning program 26 (FIG. 1) of the work plan devising server 3. If the evaluation learning program 26 receives a claim from a customer, it updates the customer information of that customer in the customer evaluation management table 31 (FIG. 1) in accordance with the processing sequence illustrated in FIG. 24.

Practically, in the case of the work plan devising system 1 according to this embodiment, if the claim information of the claim from the customer is registered in the claim information management table 17 (FIG. 3) of the customer management server 2 by the salesperson in charge, the work plan devising server 3 is notified by the customer management server 2 to that effect.

Then, if the evaluation learning program 26 of the work plan devising server 3 receives such notice from the customer management server 2, it starts the first evaluation learning processing illustrated in this FIG. 24 and firstly accesses the customer management server 2 and acquires the claim information of that claim (S60).

Subsequently, the evaluation learning program 26 extracts the classification (the delivery date, the quality, or the cost) of the claim, which is then received, from the claim information acquired in step S60 (S61). Furthermore, the evaluation learning program 26 extracts the customer ID of the customer, who is the claim source, from that claim information and acquires the customer evaluation regarding the classification, which was acquired in step S61, of the customer with that customer ID by searching the customer evaluation management table 31 by using the extracted customer ID as a keyword (S62).

Next, the evaluation learning program 26 judges whether or not the customer evaluation acquired in step S62 is other than “3” (S63). Then, if the evaluation learning program 26 obtains a negative result in this judgment, it terminates this first evaluation learning processing.

On the other hand, if the evaluation learning program 26 obtains an affirmative result in the judgment of step S63, it updates the customer evaluation management table 31 in order to change the relevant customer evaluation to just one-level more severe evaluation by incrementing (adding just 1) the customer evaluation regarding the classification, which was extracted in step S61, of the customer whose customer evaluation was acquired in step S62(S64); and the evaluation learning program 26 then terminates this first evaluation learning processing.

### (4-6) Second Evaluation Learning Processing

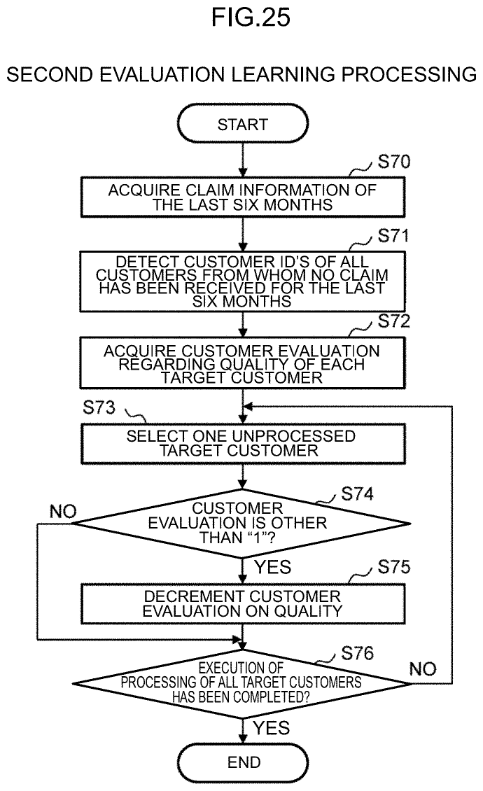

Meanwhile, FIG. 25 illustrates a processing sequence for second evaluation learning processing executed by the evaluation learning program 26. The evaluation learning program 26 updates the customer evaluation management table 31 so as to enhance the customer evaluation of a customer who has not made any claim for a certain period of time, by periodically executing this second evaluation learning processing.

Practically, after starting this second evaluation learning processing, the evaluation learning program 26 firstly accesses the customer management server 2 and acquires the claim information of the past six months, which is stored in the claim information management table 17 (FIG. 3) (S70).

Subsequently, the evaluation learning program 26 acquires the customer ID's of all customers from whom no claim has been made for the past six months, on the basis of the claim information acquired in step S70 (S71). Specifically speaking, the evaluation learning program 26 extracts the respective customer ID's from the respective pieces of claim information acquired in step S70 and extracts all the customer ID's, other than the above-extracted customer ID's, from the customer ID's registered in the customer evaluation management table 31.

Next, the evaluation learning program 26 acquires the customer evaluation regarding the quality of each of the customers, whose customer ID's were acquired in step S72 (such customers will be hereinafter referred to as the “target customers” respectively), from the customer evaluation management table 31 (S72). Furthermore, the evaluation learning program 26 subsequently selects one target customer regarding whom the processing of step S74 and subsequent steps has not been executed yet, from such target customers (S73).

Furthermore, the evaluation learning program 26 judges whether or not the customer evaluation regarding the quality, which was acquired in step S72, of the target customer selected in step S73 (hereinafter referred to as the “selected target customer”) is a value other than “1” (“2” or “3”) (S74). Then, if the evaluation learning program 26 obtains a negative result in this judgment, it proceeds to step S76.

On the other hand, if the evaluation learning program 26 obtains an affirmative result in the judgment of step S74, it updates the customer evaluation management table 31 so as to change the relevant customer evaluation to just one-level more generous evaluation by decrementing (subtracting only 1 from) the customer evaluation regarding the quality of the selected target customer (S75), and then judges whether the execution of the processing of step S74 and subsequent steps has been completed or not with respect to all the target customers.

Then, if the evaluation learning program 26 obtains a negative result in this judgment, it returns to step S73 and then repeats the processing from step S73 to step S76 by sequentially switching the target customer to be selected in step S73 to another target customer regarding whom the processing of step S74 and subsequent steps has not been executed yet.

Then, if the evaluation learning program 26 eventually obtains an affirmative result in step S76 by finishing executing the processing of step S74 and subsequent steps with respect to all the target customers, it terminates this second evaluation learning processing.

### (5) Advantageous Effects of This Embodiment

The work plan devising server 3 for the work plan devising system 1 according to this embodiment as described above learns the customer evaluation, expands the various kinds of rules which are set by the work plan devising person in charge as necessary on the basis of the learned customer evaluation, and devises (or redevises) a work plan in accordance with the expanded rules. Therefore, this work plan devising server 3 can devise a work plan in which the customer evaluation is reflected; and consequently, the optimum work plan can be devised without manual intervention.

### (6) Other Embodiments

Incidentally, the aforementioned embodiment has described the case where the present invention is applied to the work plan devising system 1 for devising a work plan for the printing work at a printing factory; however, the present invention is not limited to this example and can be applied to a wide variety of work plan devising apparatuses for devising various other work plans.

Moreover, the aforementioned embodiment has described the case where the customer evaluation is learned, the equipment rules and the customer rules which are set by the work plan devising person in charge are expanded as necessary on the basis of the learned customer evaluation, and the work plan is redevised in accordance with the expanded rules; however, the present invention is not limited to this example and the equipment rules and the customer rules may be expanded as necessary on the basis of the learned customer evaluation and an initial work plan may be devised, instead of redevising the work plan, in accordance with the expanded rules.

Furthermore, the aforementioned embodiment has described the case where the first storage apparatus that stores the rules which are set in advance in association with the printing work (the equipment rules and the customer rules), and the second storage apparatus that stores the evaluation from the customer with respect to the work result of the printing work are configured of the same one auxiliary storage apparatus 22 (FIG. 1) within the work plan devising server 3; however, the present invention is not limited to this example and the first and second storage apparatuses may be provided separately in the work plan devising server 3.

Furthermore, the aforementioned embodiment has described the case where the plan devising processing unit that devises a work plan by using the customer evaluation on the basis of the equipment rules and the customer rules is configured of the CPU 20 for the work plan devising server 3 and the plan optimization processing program 25; however, the present invention is not limited to this example and the plan devising processing program 24 may be equipped with the above-described function of the plan optimization processing program 25.

Furthermore, the aforementioned embodiment has described the case where the customer evaluation of each evaluation item is conducted as three-level evaluation, that is, “the most generous,” “generous,” and “severe”; however, the present invention is not limited to this example and the levels of the customer evaluation may be two levels or four or more levels.

Furthermore, the aforementioned embodiment has described the case where the second evaluation learning processing described earlier with reference to FIG. 25 changes the customer evaluation on the “quality” of the customer who has not made any claim for the past six months, to one-level more generous evaluation; however, the present invention is not limited to this example and the relevant customer evaluation may be updated to also change other customer evaluation values to more generous evaluation in addition to the “quality” or instead of the “quality.” Furthermore, the above-mentioned period of time may be a time period other than the last six months.

### INDUSTRIAL APPLICABILITY

The present invention can be applied to a wide variety of work plan devising apparatuses for devising work plans for various kinds of work.

### REFERENCE SIGNS LIST

1: work plan devising system

2: customer management server

3: work plan devising server

5, 7: client terminals

20: CPU

23: rule setting processing program

24: plan devising processing program

25: plan optimization processing program

26: evaluation learning program

27: machine management table

28: evaluation item management table

29: equipment rule management table

30: customer rule management table

31: customer evaluation management table

32: rule applicability management table

33: setting condition management table

60: equipment rule setting screen

70: customer rule setting screen

90: plan devising screen

100: devised plan result display screen

101: devised plan result Gantt chart

102: rule satisfaction status details list tab

101A: bar mark

101B, 104B: icon Δ

101C: icon ×

104: optimization Gantt chart

105: rule satisfaction status details (after optimization) tab

106: plan health check dialogue

110: customer evaluation display screen

1. A work plan devising apparatus for devising a work plan for work for orders from customers,
the plan devising apparatus comprising:
a first storage apparatus that stores rules which are set in advance in association with the work;
a second storage apparatus that stores an evaluation result of each of one or more evaluation items regarding each of the customers; and
a plan devising processing unit that devises the work plan on the basis of the rules by using the evaluation result of each evaluation item regarding the customers,
wherein the plan devising processing unit expands the rules as necessary according to the evaluation result of each evaluation item regarding each customer and devises the work plan according to the expanded rules.

2. The work plan devising apparatus according to claim 1,
wherein the expanded rules are rules for prioritizing quality or cost with regard to an order of the relevant customer.

3. The work plan devising apparatus according to claim 1, comprising an evaluation learning unit that updates the evaluation result of the evaluation item which is required for the customer, depending on whether there is any claim made by the customer or not.

4. The work plan devising apparatus according to claim 3,
wherein the evaluation learning unit updates the evaluation result regarding the customer in order to change the evaluation of the relevant evaluation item regarding the customer to one-level more severe evaluation according to the claim from the customer.

5. The work plan devising apparatus according to claim 3,
wherein the evaluation learning unit updates the evaluation result regarding the customer to change the evaluation result of some or all of the evaluation items regarding the customer who has made no claim for a certain period of time to one-level more generous evaluation.

6. A work plan devising method executed by a work plan devising apparatus for devising a work plan for work for orders from customers,
the work plan devising method comprising:
a first step of storing rules which are set in advance in association with the work and storing an evaluation result of each of one or more evaluation items regarding each of the customers; and
a second step of devising the work plan on the basis of the rules by using the evaluation result of each evaluation item regarding the customers,
wherein in the second step, the rules are expanded as necessary according to the evaluation result of each evaluation item regarding each customer and the work plan is devised according to the expanded rules.

7. The work plan devising method according to claim 6,
wherein the expanded rules are rules for prioritizing quality or cost with regard to an order of the relevant customer.

8. The work plan devising method according to claim 6,
wherein in the second step, the evaluation result of the evaluation item which is required for the customer is updated, depending on whether there is any claim made by the customer or not.

9. The work plan devising method according to claim 8,
wherein in the second step, the evaluation result regarding the customer is updated to change the evaluation of the relevant evaluation item regarding the customer to one-level more severe evaluation according to the claim from the customer.

10. The work plan devising method according to claim 8,
wherein in the second step, the evaluation result regarding the customer is updated to change the evaluation result of some or all of the evaluation items regarding the customer who has made no claim for a certain period of time to one-level more generous evaluation.
